(19) United States
(12) Patent Application Publication
(10) Pub. No.: US 2026/0289706 A1
(43) Pub. Date: Sep. 24, 2026

(54) SYSTEM

(71) Applicant: SoftBank Group Corp., Tokyo (JP)

(72) Inventor: Takanari SOUMA, Tokyo (JP)

(73) Assignee: SoftBank Group Corp., Tokyo (JP)

(21) Appl. No.: 19/560,289

(22) Filed: Mar. 9, 2026

(30) Foreign Application Priority Data
Mar. 19, 2025 (JP) 2025-044913

(51) Int. Cl. G06Q 50/18; G06F 40/295; G06N 3/0475; G06N 3/0499

(52) U.S. Cl. CPC G06Q 50/186; G06F 40/295; G06N 3/0475; G06N 3/0499

(57) ABSTRACT

A system includes a processor that is configured to receive information input by a user through a communication application, generate a prompt sentence for analyzing the received information and input the prompt sentence into a generative AI model, and generate advice and legal documents based on a response from the generative AI model and present the advice and legal documents to the user.

### CROSS-REFERENCE TO RELATED APPLICATION

This application is based on and claims priority under 35 USC 119 from Japanese Patent Application No. 2025-044913 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional end-of-life planning systems and legal-document preparation tools require users to manually enter highly structured information into dedicated forms or to consult directly with specialists such as lawyers or funeral directors. As a result, users face several problems, including a high psychological barrier to starting end-of-life planning, a high cost and time burden for obtaining legal advice, and difficulties in updating or revising previously prepared documents. Furthermore, existing chat-based systems are typically limited to simple question-and-answer support and are not capable of automatically generating legally effective official documents or of systematically proposing concrete procedures for funeral arrangements and inheritance succession. Accordingly, there is a need for a system that allows a user to input information in natural language through a familiar communication application, that can accurately analyze the input information by using a generative AI model, and that can automatically generate advice and legal documents and present them to the user in a timely manner.

### SUMMARY

In order to solve the above-described problems, according to one aspect of the present invention, there is provided a system comprising a processor, wherein the processor is configured to receive information input by a user through a communication application, generate a prompt sentence for analyzing the received information and input the prompt sentence into a generative AI model, and generate advice and legal documents based on a response from the generative AI model and present the advice and legal documents to the user. In addition, the processor may be configured to automatically create legally effective official documents by using the generative AI model based on input information from the user. Furthermore, the processor may be configured to provide, on the communication application, an interface for proceeding with procedures including funeral arrangements and succession, and automatically propose the procedures based on input from the user. By these means, the system enables a user to perform end-of-life planning via natural-language interaction, while automatically obtaining structured advice, legally effective official documents, and concrete procedural proposals without requiring specialized knowledge or complex manual operations.

The term “system” refers to an arrangement including at least one processor and associated hardware, software, and communication components configured to execute the functions described in the claims.

The term “processor” refers to one or more hardware processing units, such as a central processing unit (CPU), a graphics processing unit (GPU), an application-specific integrated circuit (ASIC), or a programmable logic device, which execute instructions stored in memory to perform the claimed operations.

The term “communication application” refers to a software application or service, such as a messenger application, chat application, or similar communication platform, that enables a user to exchange text, voice, image, or other data with a server or another user over a network.

The term “user” refers to a natural person or an entity that operates a terminal device and inputs information into the system through the communication application.

The term “information input by a user” refers to data including, but not limited to, text messages, selections of options, answers to questions, and other inputs provided by the user via the communication application.

The term “prompt sentence” refers to a text string or a set of text strings generated by the processor for the purpose of causing a generative AI model to analyze the received information and to produce a desired response related to advice or legal documents.

The term “generative AI model” refers to a machine learning model, such as a large language model or other generative model, that is configured to generate text or other content in response to a given input, including the above-mentioned prompt sentence.

The term “response from the generative AI model” refers to text or other output data produced by the generative AI model when the prompt sentence and related context are provided as input.

The term “advice” refers to guidance, recommendations, or explanatory information generated by the processor based on the response from the generative AI model, including but not limited to advice relating to end-of-life planning, legal matters, funeral arrangements, or inheritance.

The term “legal documents” refers to documents that have legal significance, including but not limited to wills, agreements, notifications, instructions for funeral arrangements, and other documents related to legal or quasi-legal procedures.

The term “legally effective official documents” refers to legal documents that are configured, when completed and executed in accordance with applicable laws and regulations, to have binding legal effect or to be accepted as official documents by relevant authorities or institutions.

The term “automatically create” refers to the processor generating, without manual drafting by a human expert, at least an initial version of a document by using the generative AI model and predetermined templates or rules based on information input by the user.

The term “funeral arrangements” refers to procedures and tasks related to organizing and conducting a funeral or memorial service, including, but not limited to, selecting a venue, determining attendees, specifying religious style, and coordinating with funeral service providers.

The term “succession” refers to legal and administrative procedures related to inheritance, including, but not limited to, the distribution of property, preparation of inheritance agreements, and communication with financial institutions or public authorities.

The term “interface for proceeding with procedures” refers to a user interface provided on the communication application that allows the user to view, select, initiate, or manage steps related to funeral arrangements, succession, or other procedures, and to input instructions that the processor uses to propose or automate those procedures.

The term “automatically propose the procedures” refers to the processor generating, based on the user's input, one or more suggested steps, workflows, or task lists for funeral arrangements or succession, without requiring the user to manually design or specify each individual procedural step.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

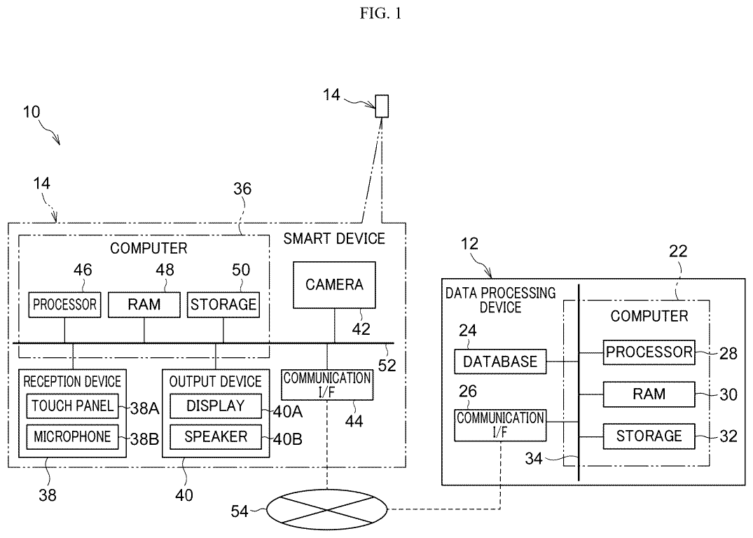

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

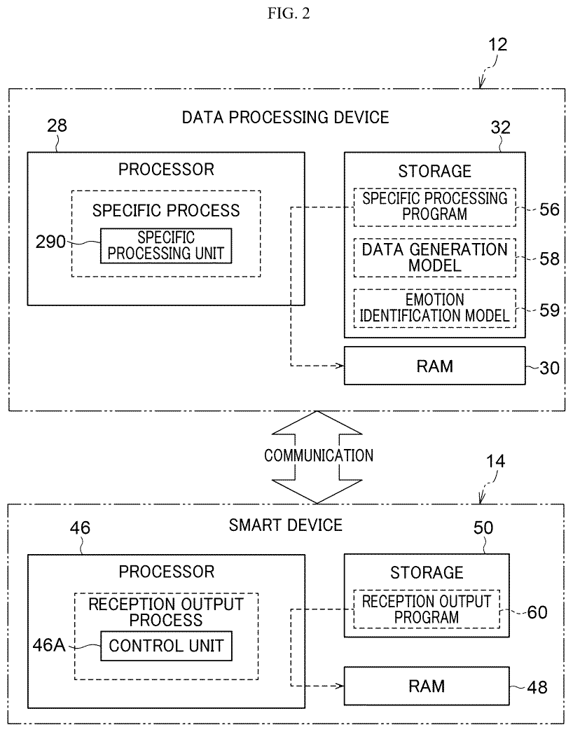

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented systems for assisting with inheritance planning, funeral arrangements, and preparation of legally oriented documents typically operate as static form-filling tools or simple question-and-answer interfaces. In such systems, a user manually enters asset information and intentions into predefined fields, and the system merely stores the raw input or generates a fixed template document. These systems generally lack the capability to understand natural language inputs in depth, to adaptively request missing information, or to iteratively refine document content in response to evolving user inputs. As a result, substantial manual intervention by legal professionals or operators is required to transform loosely structured user narratives into consistent, complete, and machine-processable data suitable for document generation and procedural guidance.

Further, in many existing architectures, natural language processing and document generation are implemented as loosely coupled or batch-processed components. A user's free-text input is not continuously converted into a persistent, structured representation that can be reused across multiple interactions, procedures, and document types. Consequently, the system cannot automatically track the progress of complex procedures (such as multi-step inheritance workflows), cannot contextually alter prompts sent to a generative AI model, and cannot dynamically update draft documents in response to partial or corrected information. This leads to redundant data entry, inconsistent document content, and increased risk of error.

Additionally, conventional use of generative AI models in document-assistance scenarios often treats the generative AI model as a black box that receives raw user text and returns a single-pass output. Such approaches do not leverage a systematic mechanism to (i) extract key semantic elements such as asset categories, beneficiary entities, locations, quantities, and evaluation values, (ii) generate machine-readable structured information, (iii) automatically derive follow-up questions for deficient or ambiguous information, and (iv) feed back refined structured information into subsequent model prompts. This lack of a structured feedback loop limits the reliability, explainability, and efficiency of AI-assisted document generation.

Moreover, existing systems typically do not integrate secure communication, iterative AI-driven advice, and automatic document composition into a unified, processor-centric architecture. Without such integration, it is difficult to ensure that user inputs are transmitted and processed securely, that advice and procedural plans are consistently aligned with the current state of user data, and that draft documents remain synchronized with the latest user intentions. This results in a fragmented user experience and increased computational overhead due to repeated, uncoordinated processing of similar data.

Accordingly, there is a need for an improved computer-implemented system and processing architecture that (i) receives natural language inputs from a user via a communication application, (ii) converts those inputs into structured information through natural language processing, (iii) uses a generative AI model in a controlled, prompt-based manner to generate advice and identify missing information, (iv) iteratively refines stored information and document candidates in response to user follow-up inputs, and (v) automatically generates and delivers electronic document candidates and procedure plans. Such a system should improve the functioning of the computer by providing tighter integration between secure communication, natural language understanding, generative AI prompting, stateful data management, and automatic document composition, thereby reducing redundant processing, minimizing user burden, and enhancing the reliability and consistency of generated outputs.

The specific processing by the specific processing unit 290 of the data processing device 12 in Example 1 is realized by the following means.

The present invention provides a server comprising a processor and a memory storing instructions that, when executed by the processor, cause the processor to function as at least: a communication control unit configured to receive character information representing asset information or intention information generated by a user inputting the asset information or the intention information as text via a communication application executed on an information processing terminal, to convert the character information into structured information, and to transmit the structured information via an encrypted communication path; a natural language processing unit configured to receive the structured information, to perform natural language processing on the structured information to extract at least one of an asset category, a beneficiary entity, a location, a quantity, and an evaluation value, and to generate an analysis prompt sentence including an extraction result and the character information; a generative-model interaction unit configured to input the analysis prompt sentence into a generative AI model and to receive response information output from the generative AI model; an advice generation unit configured to generate advice information including at least one of an option presentation, an additional information request, and a procedure guidance based on the response information and to cause the advice information to be displayed on a user interface of the communication application; a data management unit configured to store the structured information and the response information in association with stored information in a storage device and to generate official document candidate data by automatically arranging document data, which constitutes at least one of a testament-related document, a funeral-related document, and an inheritance-related document, into a document format using the stored information; and a document delivery unit configured to transmit the official document candidate data in an electronic document format to the information processing terminal and to provide the official document candidate data so as to be obtainable via the communication application. This enables an integrated, computer-implemented workflow in which user-provided natural language inputs are securely acquired, algorithmically structured, iteratively refined via controlled prompt sentences to a generative AI model, and automatically composed into synchronized advice outputs, procedure plans, and electronic document candidates, thereby improving the efficiency, reliability, and technical performance of the underlying information processing system.

The term “system” refers to a combination of hardware and software components that cooperate to execute information processing functions, including at least one processor, a memory, communication interfaces, and executable programs.

The term “processor” refers to a hardware processing unit, such as a central processing unit or other arithmetic and logic circuitry, configured to execute instructions stored in a memory to perform specified operations.

The term “memory” refers to a non-transitory computer-readable storage medium, including volatile or non-volatile storage, configured to store programs, data, and parameters for use by the processor.

The term “information processing terminal” refers to an electronic apparatus operated by a user, including at least one processor, a display, an input interface, and a network interface, and configured to execute an application for communication with a remote server.

The term “communication application” refers to an application program executed on an information processing terminal, which provides a user interface for transmitting and receiving data messages, including at least text messages, over a communication network.

The term “character information” refers to data representing text input by a user, including alphanumeric characters, symbols, and other textual content that describes asset information, intention information, or responses to prompts.

The term “asset information” refers to information indicating the existence, type, characteristics, quantity, location, or evaluation value of property, including but not limited to real property, movable property, financial instruments, and other economic resources.

The term “intention information” refers to information indicating a user's wishes, preferences, or decisions with respect to distribution of assets, selection of beneficiaries, funeral arrangements, or related procedures.

The term “structured information” refers to data derived from character information and represented in a machine-readable format, including fields, labels, or key-value pairs, enabling systematic storage, retrieval, and processing by a computer.

The term “encrypted communication path” refers to a communication channel established over a network, in which transmitted data is encrypted using a cryptographic protocol to ensure confidentiality and integrity between endpoints.

The term “natural language processing” refers to a computational technique that analyzes text data to identify linguistic or semantic features, including tokenization, part-of-speech tagging, entity recognition, and extraction of relevant concepts.

The term “asset category” refers to a classification of an asset, such as real property, movable property, financial asset, or other general class of property, which is identifiable by natural language processing from user inputs.

The term “beneficiary entity” refers to a person, group, or organization designated or implied as a recipient of assets, rights, or instructions, as determined from user-provided character information.

The term “location” refers to information indicating a geographic position or address associated with an asset, event, or subject matter, including at least region names, city names, postal codes, or property addresses.

The term “quantity” refers to information indicating an amount or number associated with an asset or item, including but not limited to counts, ratios, or shares.

The term “evaluation value” refers to information indicating an assessed monetary value or relative worth of an asset, including estimated market price or appraisal value.

The term “analysis prompt sentence” refers to a text sequence generated by the system, including at least user-provided character information and extracted features, and formatted as an input instruction for a generative AI model.

The term “generative AI model” refers to a machine-learned computational model configured to generate text or other data outputs in response to input text, based on probabilistic relationships learned from training data.

The term “response information” refers to data output by the generative AI model in response to an analysis prompt sentence, including at least textual content representing suggestions, interpretations, or questions.

The term “advice information” refers to information derived from response information, including at least one of option presentations, additional information requests, and procedure guidances, which is intended to guide user actions or decisions.

The term “option presentation” refers to advice information that enumerates multiple alternative choices, strategies, or configurations that a user may select or consider.

The term “additional information request” refers to advice information that explicitly identifies missing or insufficient data and prompts the user to provide such data.

The term “procedure guidance” refers to advice information that indicates steps, orders, or required items for executing a procedure, including inheritance procedures, funeral procedures, or asset distribution procedures.

The term “user interface of the communication application” refers to a visual or interactive display area provided by the communication application, through which a user views messages and inputs responses.

The term “stored information” refers to data maintained in a storage device, including at least structured information, response information, historical user inputs, and intermediate results used for document generation and procedure planning.

The term “storage device” refers to a hardware apparatus or subsystem, such as a disk drive, solid-state drive, or storage array, configured to store data persistently for later retrieval by the processor.

The term “official document candidate data” refers to document data generated by the system that is formatted as a draft of a formal document, suitable for review or modification, and representing a user's intentions or procedural information.

The term “document data” refers to content elements such as textual clauses, headings, and structured segments, which can be arranged into a document format to represent a legal or procedural record.

The term “document format” refers to a structural arrangement of document data, including ordering, sections, and standardized expressions, intended for use as a legally oriented or formal document template.

The term “testament-related document” refers to a document that records intentions concerning transfer of assets or rights upon death, including at least a will draft or related instruction document.

The term “funeral-related document” refers to a document that records intentions or instructions concerning funeral arrangements, ceremonies, or related posthumous events.

The term “inheritance-related document” refers to a document that records information necessary for inheritance procedures, including distribution of assets, identification of beneficiaries, or related administrative actions.

The term “electronic document format” refers to a machine-readable file format for representing a document, such as a text file, markup file, or page description file, suitable for transmission and display by electronic means.

The term “deficient information item” refers to a data element that is required or useful for accurate advice or document generation but is missing, incomplete, or ambiguous in the current stored information.

The term “additional-input prompt sentence” refers to a prompt sentence generated to request one or more deficient information items from a user, including explicit questions or input instructions.

The term “procedure plan” refers to a structured representation of one or more procedures, including at least a procedure category, an execution order, and required information, for completing inheritance-related, funeral-related, or asset-distribution-related tasks.

The term “procedure category” refers to a classification of a procedure, including but not limited to a funeral-related procedure, an inheritance-related procedure, or an asset-distribution-related procedure.

The term “execution order” refers to an arrangement indicating a sequence in which a plurality of sub-procedures or actions should be performed to complete a procedure plan.

The term “required information” refers to data elements necessary or recommended for execution of a procedure step, including specific asset details, participant information, or document references.

The term “guidance user interface” refers to a user interface screen or view that presents a procedure plan, progress state, and related instructions to assist a user in performing procedures.

The term “progress state” refers to status information indicating a current stage, completion level, or pending actions for one or more procedures managed by the system.

The term “prompt sentence” refers to a text sequence formatted as an instruction or query to be input into a generative AI model, including an analysis prompt sentence and an additional-input prompt sentence.

Various embodiments for carrying out the invention will now be described. In the following description, a server executes back-end processing, a terminal provides a user interface and communication functions, and a user operates the terminal to input information. The same reference architecture can be implemented on different hardware and software platforms without departing from the scope of the claims.

Server uses at least one processor, a main memory, a non-volatile storage device, and a network interface. For example, server runs on a general-purpose computing platform such as a rack-mounted computer or a virtual machine in a data center. Server executes an operating system such as a generic UNIX-like system, a general-purpose server operating system, or a cloud-based managed runtime, and executes application software implemented by a web framework such as a generic HTTP application framework. Server also uses a database management system such as a relational database server or a document-oriented database, and a model execution runtime based on a numerical computation framework such as a tensor computation library.

Terminal uses at least one processor, a memory, a display device, an input device, and a wireless or wired communication interface. For example, terminal can be a smartphone running a generic mobile operating system, a tablet computer, or a personal computer running a generic desktop operating system. Terminal executes a communication application implemented as a native mobile application or a web application in a browser. Terminal provides a text input area and a message display area and communicates with server via a secure network protocol.

User operates terminal to input asset information and intention information as text. User launches the communication application and views a chat-like screen. Terminal displays an input field in which user can type a prompt sentence, such as:

“I want to consult about how to distribute my real estate among my children.” or

“I own an apartment in Osaka and a detached house in Tokyo. I want to leave the apartment in Osaka to my eldest son and the house in Tokyo to my two daughters. Please advise how I should describe this in my will, and what information is missing.”

Terminal captures keystrokes or touch inputs, converts them into character information, and temporarily stores this character information in local memory. Terminal then passes this character information to a communication module that constructs a request message including at least a user identifier, a timestamp, and the prompt sentence. Terminal uses a transport stack that implements an encryption protocol such as a transport layer security protocol to establish an encrypted communication path with server. Terminal sends the request message to server using an HTTP-based protocol.

Server receives the request message through a network interface. Server terminates the encrypted session using a cryptographic library provided by the operating system or a general cryptographic library. Server passes the decrypted payload to an application layer module. Server parses the payload and separates the prompt sentence, any previously stored context identifiers, and metadata such as the language, device type, and session identifier.

Server uses a natural language processing module to convert character information into structured information. In one embodiment, server uses a tokenizer implemented by a language processing library. Server decomposes the prompt sentence into tokens corresponding to words or subword units. Server then uses a part-of-speech tagger and a named-entity recognizer to detect candidate entities and semantic roles. Server identifies and normalizes asset-related expressions (for example, “apartment,” “detached house,” “real estate”), beneficiary-related expressions (for example, “children,” “eldest son,” “two daughters”), location-related expressions (for example, “Osaka,” “Tokyo”), and numerical or quantitative expressions (for example, “three children,” “80 million yen”). Server maps detected expressions to an internal ontology in which higher-level classes such as “real property,” “beneficiary,” “geographic location,” “cardinal number,” and “monetary value” are defined.

Server builds structured information as a data structure, for example a set of key-value pairs or records, in which keys correspond to generalized attributes like “asset_category,” “beneficiary_entity,” “location,” “quantity,” and “evaluation_value.” Server stores this structured information in a database together with an association to the user identifier and the original character information. By using higher-level classes instead of raw text fields, server reduces redundancy and enables more efficient indexing and retrieval. This specific data structuring improves query performance and prevents repeated parsing of the same text in subsequent interactions, which results in lower latency and reduced processing load.

Server constructs an analysis prompt sentence based on the original prompt sentence and the structured information. In one embodiment, server generates a multi-part text in which a role description, context summary, and user question are explicitly separated. For example, server may generate a prompt sentence such as:

“You are an assistant that provides non-binding guidance for inheritance planning and will preparation. The user owns real estate assets and wishes to distribute them among beneficiaries. The extracted information is: asset category: real estate; beneficiaries: children; locations: urban area. Based on this, please propose possible distribution methods and indicate what additional information is required.”

or, after additional inputs by user:

“You are an assistant that provides non-binding guidance for inheritance planning and will preparation. The user owns one apartment in central Tokyo valued at about 80 million yen and has three children. The user wants to minimize conflicts among the children. Based on this, please suggest a fair distribution plan and list any remaining missing information.”

Server then inputs this analysis prompt sentence into a generative AI model. In one embodiment, server uses a generative AI model implemented as a transformer-type neural network. This model includes a series of encoder and decoder layers or a stack of self-attention layers. Each layer consists of a multi-head self-attention sub-layer and a position-wise feed-forward sub-layer with non-linear activation functions. Server uses a model that has been trained beforehand on a large text corpus using a language modeling objective, where the model minimizes a loss function such as cross-entropy between predicted token distributions and actual tokens. During training, server or an external training environment updates model parameters, including weight matrices and bias vectors, using an optimization algorithm such as stochastic gradient descent with adaptive moment estimation. Training data may be augmented using techniques such as synonym replacement, paraphrasing, and shuffling of sentence order to improve model robustness.

Server uses a tokenizer and an embedding module associated with the generative AI model to convert the analysis prompt sentence into a sequence of numeric vectors. Server feeds these vectors into the model, which performs a series of matrix multiplications, scaling, and softmax operations to compute attention weights across tokens. The model then produces a sequence of output token probabilities, which server decodes into response information as text. Server can also constrain the generation using parameters such as maximum sequence length, temperature, and nucleus sampling threshold to control diversity and coherence.

Server does not simply forward this response information directly to user. Instead, server uses a rule-based post-processing module and a secondary classification module to interpret the response information in a technically distinct manner. For instance, server scans the generated text for markers indicating missing information (for example, phrases like “please provide,” “it is necessary to know,” or “missing details include”). Server extracts deficient information items by matching these markers against a predefined pattern library and by checking which standardized attributes in the structured information remain unset or ambiguous. Server converts these deficient information items into one or more explicit additional-input prompt sentences, such as:

“Please provide the full address and registration details of the apartment in Osaka and the detached house in Tokyo.”

or

“Please specify the number of children and whether any special conditions (such as existing loans or co-ownership) apply to the real estate.”

Server also generates advice information by segmenting the response information into sections such as “Summary,” “Option A,” “Option B,” and “Required Data.” This segmentation can be performed using a section-detection model or rule-based heuristics that identify headings and connective expressions. By structuring the response information in this way, server can store, reference, and reuse specific advice components across multiple steps without regenerating entire responses, thereby improving computational efficiency and reducing communication load.

Server stores both the advice information and the deficient information items in association with the user's stored information in the database. When user subsequently sends additional inputs, server updates existing structured information records by merging new values and marking resolved attributes. Server avoids re-parsing previously processed sentences by relying on the stored structured information and only applying natural language processing to new text segments. This incremental update mechanism improves processing speed and reduces resource usage, which constitutes a technical improvement over systems that repeatedly reprocess entire histories of user messages.

Terminal receives advice information and additional-input prompt sentences from server. Terminal presents these items to user through the communication application. Terminal formats advice as chat bubbles or bullet lists and presents additional-input prompt sentences as input hints or selectable templates. User can simply tap a suggested question to answer it, or can type a more detailed free-text response. By reducing the cognitive load on user and by guiding user through structured queries, the system decreases input errors and supports more consistent data acquisition.

Server gradually accumulates a comprehensive set of structured information representing user's assets, beneficiaries, and preferences. When server determines that sufficient information has been collected, server uses a document generation module to produce official document candidate data. In one embodiment, server stores document templates as text structures with placeholders that correspond to generalized attributes like “asset_category,” “beneficiary_entity,” “location,” “quantity,” and “evaluation_value.” Server then performs a template filling operation, in which server inserts specific stored values into these placeholders. For example, server generates testament-related clauses that explicitly state that a particular property at a given address is to be assigned to named beneficiaries in specified shares.

Server can optionally use the generative AI model to refine natural language around the filled placeholders, but server controls this process by providing a constrained prompt sentence that includes explicit instructions to preserve legal terms and to avoid altering structural relationships among data fields. Server then stores the resulting document text in the database and converts it into an electronic document format such as a paginated layout file or a markup-based file. Server transmits a link or file to terminal, allowing user to display or download the document. This pipeline uses the structured information as an intermediate representation to ensure that technical operations on the data remain consistent, and it separates document logic from user dialogue logic, which constitutes an architectural improvement.

Server, terminal, and user jointly contribute to an iterative refinement loop that improves not only user experience but also the technical performance of the system. Server monitors processing times and error rates and can adjust internal thresholds, such as maximum prompt length or frequency of database writes, to maintain performance under load. For instance, server may compress historical advice segments into summaries using the generative AI model when the amount of stored message data for a particular user exceeds a predetermined limit. By doing so, server reduces storage size and communication payloads while preserving key information, thereby optimizing resource utilization.

In one variation, server uses a hybrid rule-based and neural approach to generate prompts. Server first uses deterministic rules to map certain asset categories and procedure types to standard prompt fragments and then combines these fragments with user-specific context and structured information.

This approach ensures that core instructions to the generative AI model maintain a consistent structure, which stabilizes the model's behavior and reduces variability in outputs. Because prompt structure has a direct effect on the computational pattern inside the generative AI model—by influencing attention distributions and token activations—this design choice contributes to improved accuracy and predictability of the model's responses.

In another embodiment, server uses a specialized evaluation module to measure consistency between response information and stored structured information. Server computes similarity scores between generated text segments and known attribute values using vector representations derived from an embedding layer. If server detects substantial inconsistency, server can automatically regenerate the analysis prompt sentence with an explicit correction instruction or can flag the segment for later review. This internal verification loop reduces semantic errors and enhances the reliability of generated documents, which is a technical improvement over straightforward one-pass generation.

Server can also adapt to different terminal capabilities. For example, when terminal has limited processing power or network bandwidth, server can compress advice information into shorter segments and reduce the rate at which rich media or large documents are transmitted. Conversely, when terminal supports larger displays, server can send more detailed procedure plans, including step-by-step graphical representations. By adjusting the content and structure of responses based on device characteristics, the system reduces communication load and improves processing efficiency.

The described architecture is not limited to inheritance and funeral contexts. The same mechanism for parsing natural language inputs, generating structured information, controlling generative AI models via tailored prompt sentences, and repeatedly refining and composing documents can be applied to other domains where structured data capture and complex document generation are required. However, in all embodiments, server, terminal, and user interact through a technically constrained pipeline that includes specific data structures, neural network operations, and rule-based modules, thereby preventing the system from being a mere automation of human mental activity.

Because server uses structured representations, ontology-based mapping, and iterative neural inference with controlled prompt sentences, server improves the functioning of the computer system itself. Data retrieval is faster due to indexed, normalized attributes; communication overhead is reduced because incremental updates avoid sending or reprocessing entire histories; and inference accuracy is improved by feeding back extracted semantic information into subsequent prompts. The combination of these elements produces a concrete technical effect: decreased response latency, reduced error rate in generated documents, and improved utilization of computational and communication resources.

Alternative embodiments can modify particular components while maintaining the same overall principles. For instance, server may employ a different type of generative AI model, such as a sequence-to-sequence recurrent neural network, a hybrid encoder-decoder model, or a smaller distilled transformer model for environments with limited computational resources. Server may also substitute different natural language processing libraries, different database engines, or different encryption protocols. Terminal may be realized as a voice-enabled device in which speech recognition converts voice input into character information, and the same back-end processing applies. In each case, server, terminal, and user can still cooperate in the same way to achieve the technical benefits of structured information extraction, controlled generative processing, and automated document composition.

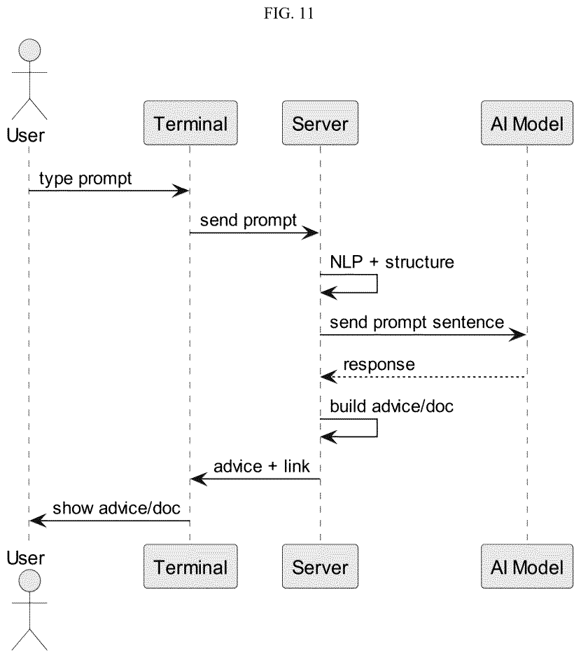

The following describes the processing flow using FIG. 11.

### Step 1

User operates the terminal to launch the communication application and input a prompt sentence. User views a text input area and types character information such as “I want to consult about how to distribute my real estate among my children.” The input of this step is the user's keystrokes or touch events, and the output is a completed text string stored in the terminal's memory. Terminal collects these events, concatenates characters into a string, and creates an internal representation of the prompt sentence.

### Step 2

Terminal converts the prompt sentence into a request message and prepares it for secure transmission. Terminal takes as input the text string from Step 1 and metadata such as user identifier and timestamp, and outputs a formatted message object including the prompt sentence. Terminal performs data processing by placing the text into predetermined fields and adding headers. Terminal then invokes a network stack to encrypt the message using a transport layer security protocol, producing an encrypted binary stream as the final output of this step.

### Step 3

Server receives the encrypted binary stream and recovers the original request message. Server takes as input the encrypted stream arriving at its network interface and outputs a decrypted payload containing the prompt sentence, metadata, and session information. Server uses cryptographic algorithms implemented in a security module to perform decryption and message integrity checks. Server parses the payload to separate the prompt sentence from associated identifiers, thereby generating structured internal variables representing the request.

### Step 4

Server converts the character information into structured information using natural language processing. Server takes as input the prompt sentence text and outputs a structured representation with fields such as asset category, beneficiary entity, location, quantity, and evaluation value. Server executes tokenization, part-of-speech tagging, and named entity recognition algorithms to segment the text into tokens, assign grammatical roles, and detect entities. Server then maps recognized entities to generalized classes, storing results in a data structure with normalized attributes.

### Step 5

Server stores the structured information and the original prompt sentence in a storage device. Server takes as input the structured representation from Step 4 and the raw text prompt, and outputs a persistent record associated with the user identifier. Server performs data processing by constructing a database insert command or document and writing it to a storage engine. This operation assigns a record identifier and updates indices so that the stored information can be quickly retrieved later.

### Step 6

Server generates an analysis prompt sentence to control the generative AI model. Server takes as input the structured information and the original prompt sentence and outputs a composed prompt sentence specifically formatted for the generative AI model. Server concatenates a role description, a summary of extracted fields, and the original user question. Server performs string operations and template substitution to embed attribute values such as asset categories and number of beneficiaries into the analysis prompt sentence.

### Step 7

Server encodes the analysis prompt sentence and invokes the generative AI model. Server takes as input the analysis prompt sentence from Step 6 and outputs response information generated by the model. Server first applies a tokenizer to transform the prompt into a sequence of tokens, then converts each token into an embedding vector. Server feeds these vectors into a transformer-based generative AI model, which performs matrix multiplications, attention weight calculations, and non-linear activations across multiple layers. The model's output logits are converted into token probabilities, from which server samples or selects the most likely token sequence and decodes it back into text, producing the response information.

### Step 8

Server post-processes the response information to extract advice information and deficient information items. Server takes as input the raw response text from Step 7 and outputs structured advice information and a list of additional information requests. Server applies pattern matching rules and, optionally, a classifier to detect segments that describe options, requests for more data, and procedure guidance. Server then splits the response into labeled sections and identifies missing attributes by comparing required fields against the existing structured information. The resulting output includes advice text and explicit questions for unresolved attributes.

### Step 9

Server updates stored information with newly derived semantic content and prepares a reply message. Server takes as input the structured advice and deficient information items from Step 8 and the previously stored record from Step 5. Server outputs an updated database record and a reply payload to be sent to terminal. Server performs data processing by adding references to advice sections, tagging which attributes are still missing, and writing these updates to storage. Server then constructs a reply payload that includes advice text and additional-input prompt sentences, formatted as textual content for the communication application.

### Step 10

Server transmits the reply payload to terminal over an encrypted channel. Server takes as input the reply payload and outputs an encrypted response stream. Server uses a transport layer security module to encode the reply, then sends the encoded stream through its network interface. Terminal receives this stream, decrypts it with its own network stack, and reconstructs the reply payload, which becomes the input for further processing on the terminal side.

### Step 11

Terminal displays advice information and additional-input prompt sentences to user. Terminal takes as input the reply payload containing advice text and questions and outputs a rendered user interface on the display. Terminal parses the payload into UI elements, creates message bubbles, and shows textual advice such as “You can distribute the real estate equally among your children or assign it to one child with financial compensation to the others,” together with questions such as “How many children do you have?” or “What is the approximate market value of the property?” This transformation converts structured message fields into visual components and interactive elements.

### Step 12

User reviews the advice and provides additional input based on the additional-input prompt sentences. User takes as input the displayed questions and advice and outputs new character information describing more detailed asset or intention information. For example, user may type: “I own one apartment in central Tokyo valued at about 80 million yen, and I have three children. Please suggest a fair distribution plan.” Terminal again collects this input, turning interaction events into another text string for further processing.

### Step 13

Terminal prepares and sends an updated request message containing both new character information and implicit linkage to prior context. Terminal takes as input the new text string and existing identifiers for the conversation and outputs a new encrypted request to server. Terminal performs data processing by including a reference to the previous record or session, thereby allowing server to correlate new information with stored structured information. The resulting encrypted request is sent through the same secure communication path as before.

### Step 14

Server merges the newly received character information with existing structured information. Server takes as input the new prompt sentence and the user's previous structured record and outputs an updated structured representation. Server re-applies natural language processing to only the new text, extracting updated asset categories, beneficiary entities, locations, quantities, and evaluation values. Server then updates specific fields in the stored record, marks previously missing attributes as resolved, and recomputes any derived values, such as total asset value or share ratios.

### Step 15

Server generates a refined analysis prompt sentence and obtains refined advice from the generative AI model. Server takes as input the updated structured information and the new user text and outputs refined response information. Server constructs a new analysis prompt sentence that includes the clarified details, such as “one apartment in central Tokyo valued at about 80 million yen” and “three children,” and repeats the encoding and inference process through the generative AI model. The resulting response information typically contains more concrete distribution recommendations and fewer missing data requests.

### Step 16

Server creates or updates official document candidate data using the accumulated structured information. Server takes as input the fully or partially completed structured information and outputs document text formatted according to predetermined templates. Server selects appropriate clause templates based on asset categories and beneficiary patterns and replaces placeholders with actual attribute values. Server can optionally apply constrained text refinement through the generative AI model, using a prompt sentence that instructs the model to improve clarity without changing legal relationships. The output of this step is structured document text representing a draft will or related document.

### Step 17

Server converts the document text into an electronic document format and stores and distributes it. Server takes as input the document text from Step 16 and outputs a file in a standardized format and a corresponding link or identifier. Server uses a document rendering module to paginate the text or to wrap it in markup. Server writes the resulting file to a storage system and records its reference in the database. Server then prepares a response message to terminal that includes a notice such as “A draft will document has been prepared based on your inputs” and a retrieval link to the document file.

### Step 18

Terminal receives the notice and link and presents document access options to user. Terminal takes as input the server's response message and outputs a user interface element, such as a button labeled “View draft will document.” Terminal, upon user interaction, requests the file from server via the link, displays the document on the screen, or opens it in an external viewer. This step completes the flow from initial natural language input through structured processing and generative AI inference to the concrete delivery of an electronic document to user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional computer-implemented systems for estate planning, asset management, and inheritance distribution, a server typically stores static user data and generates fixed-form documents or workflows according to predetermined rules. Such systems require human experts to interpret fragmented user inputs, to manually consolidate asset information and intentions into consistent planning data, and to translate the planning data into legally compliant documents and executable transaction instructions. As a result, the overall process is slow, error-prone, and difficult to scale, and the computing resources of the server are not effectively utilized to automate higher-level reasoning tasks.

Further, known systems do not effectively manage long-running conversational interactions in which a user incrementally provides asset information and intention information over time via a communication application. Incoming messages are often stored as unstructured text without being continuously integrated into a coherent machine-usable context that includes asset information, heir candidate information, and intention information. Consequently, the server must repeatedly perform ad hoc parsing and reconciliation, leading to redundant computation, inconsistent planning results, and increased latency in generating updated plans and documents.

Moreover, conventional systems that incorporate machine learning components typically invoke a model on a single input and directly display the model's output to the user. These systems lack a robust mechanism for programmatically constructing and controlling prompt sentences that guide a generative AI model to produce structured outputs, such as an asset management plan, an inheritance distribution plan, and a draft of a legally effective official document. Without such controlled prompting and structured post-processing, the server cannot reliably transform natural-language model outputs into machine-verifiable plan information and document data that satisfy legal and transactional constraints.

Additionally, existing document generation systems mainly perform template filling based on pre-defined form fields, without closely coupling generative model analysis results with legal format templates. They do not support dynamic selection of format templates based on an analysis of the user's context, nor do they ensure that the generated documents are consistently aligned with the computationally derived plan information. This disconnect can result in discrepancies between planning data and document contents, which in turn complicates downstream transaction execution and legal procedures.

Furthermore, conventional electronic payment integration is typically decoupled from the higher-level inheritance and asset management logic. A payment module may accept user-defined transactions, but it is not automatically driven by a machine-generated inheritance distribution plan that has been validated and stored as structured plan information. This separation requires manual re-entry or mapping of plan data into transaction requests, increasing the risk of human error and preventing end-to-end automation of asset movement and settlement in accordance with the generated plans.

Also, existing systems provide only limited support for life-cycle management of estate-related information. They often do not maintain a clear distinction between provisional, user-editable planning states and finalized, legally relevant records that are suitable for sharing with heir candidates upon a specified trigger event. As a result, servers may inadvertently present outdated or incomplete information to heirs, causing confusion, additional administrative overhead, and a higher likelihood of disputes.

In view of the foregoing, there is a need for an improved computer-implemented system and server architecture that (i) continuously integrates user input information into structured context information, (ii) programmatically generates and controls prompt sentences for a generative AI model to obtain structured analysis results, (iii) transforms those results into consistent plan information and legally effective document data through template selection and document file generation, (iv) links plan information to electronic settlement services for automated transaction execution, and (v) manages record states so that only finalized information is shared with heir candidates. Such a system should improve the functioning of the server by reducing redundant parsing, enforcing structured data flows around the generative AI model, enhancing consistency between computational plans and legal documents, and enabling reliable, automated distribution of finalized information to relevant parties.

The specific processing by the specific processing unit 290 of the data processing device 12 in Application Example 1 is realized by the following means.

The present invention provides a server comprising a processor configured to receive, via a communication function of a user terminal, input information from a user including asset information and intention information; to generate context information including the asset information, heir candidate information, and intention information by integrating the received input information with history information stored in association with the user; to generate, based on the context information, a prompt sentence for causing a generative information processing model to analyze the input information and to generate an asset management plan and an inheritance distribution plan, and to input the prompt sentence to the generative information processing model; to extract and verify, as structured data, an analysis result output from the generative information processing model, and to store the structured data as plan information representing the asset management plan and the inheritance distribution plan; to select, based on the analysis result, a format template satisfying legal requirements, and to generate document data of a legally effective official document by automatically assigning the plan information and the intention information to the format template; to convert the document data into a document file format, to store the document file in a storage device, and to provide reference information of the document file to the user terminal; to transmit settlement request data to an external electronic settlement service to execute a fund transfer or payment process based on the inheritance distribution plan, and to store a response result from the external electronic settlement service in association with the plan information; and to manage record information including the asset information, the intention information, the plan information, and the document data in a state during editing while the user is alive and in a state after finalization in a distinguishable manner, to add management information indicating a finalized state to the record information in response to a finalization instruction from the user, and to designate only the record information having the finalized state as a target for sharing with an heir candidate. This enables the server to improve computer functionality by systematically transforming unstructured conversational input into machine-verifiable plan information and legally effective document data via controlled interaction with a generative AI model, by reducing redundant parsing and manual mapping between planning results, documents, and settlement operations, by ensuring consistency between stored plans and generated documents through template-based composition, and by reliably limiting automated sharing and transaction execution to finalized records, thereby enhancing the efficiency, reliability, and scalability of estate planning and inheritance processing.

The term “user terminal” refers to an information processing device operated by a user, such as a computing device having a communication function, a display function, and an input function, and is capable of exchanging data with a server over a communication network.

The term “communication function” refers to a hardware and software capability of a device that enables transmission and reception of data over a communication network using one or more communication protocols.

The term “input information” refers to data provided by a user via the user terminal through a user interface, including at least asset information and intention information, and optionally including free-form text, structured selections, or other user-specified parameters.

The term “asset information” refers to data representing property of the user, including but not limited to financial assets, real property, movable property, claims, or other items of value, together with associated attributes such as type, identifier, and valuation.

The term “intention information” refers to data representing the user's wishes, preferences, or policies regarding management, disposition, or distribution of the asset information, including but not limited to inheritance preferences and usage conditions.

The term “history information” refers to information stored in association with a user that includes past input information, past plans, and other previously recorded data relevant to the user's assets and intentions.

The term “context information” refers to composite data generated by integrating input information with corresponding history information, the composite data including at least asset information, heir candidate information, and intention information, arranged in a machine-usable format.

The term “heir candidate information” refers to data representing persons or entities that are potential recipients of assets of the user, including at least identifiers, relationship attributes, and contact information.

The term “prompt sentence” refers to a text string or equivalent representation generated by the processor for input to a generative information processing model, the text string being configured to instruct the model to perform a specific analysis or generation task based on the context information.

The term “generative information processing model” refers to a trained computational model, such as a generative artificial intelligence model, configured to receive a prompt sentence as input and to output generated information including analysis results, plans, summaries, or document drafts.

The term “analysis result” refers to information output from the generative information processing model in response to a prompt sentence, the information including at least data describing an asset management plan and an inheritance distribution plan.

The term “asset management plan” refers to structured data that specifies how a user's assets are to be managed, allocated, or otherwise handled over time in accordance with the user's intentions.

The term “inheritance distribution plan” refers to structured data that specifies how a user's assets are to be distributed among heir candidates or other recipients, including allocation rules, percentages, or conditions.

The term “structured data” refers to data organized in a defined format such as records, fields, or key-value pairs, which allows programmatic interpretation, verification, and storage by the processor.

The term “plan information” refers to structured data representing at least the asset management plan and the inheritance distribution plan generated or updated by the processor.

The term “format template” refers to a data structure or document pattern defining an arrangement of sections, fields, and legal clauses, and configured to be filled with plan information and intention information to generate a legally compliant document.

The term “legal requirements” refers to conditions defined by applicable laws or regulations that a document or process must satisfy in order to be considered valid or effective in a legal context.

The term “document data” refers to digital data representing contents of a document, including text and optionally formatting information, before or after application of a format template.

The term “official document” refers to a document intended to be used in formal procedures, including but not limited to wills, agreements, or directives, and structured such that it can satisfy relevant legal requirements when appropriately executed.

The term “document file format” refers to a digital file representation of document data suitable for storage and viewing, such as a portable document format or other structured document file type.

The term “storage device” refers to a hardware and software combination capable of storing digital data persistently, including but not limited to semiconductor memory, magnetic storage, optical storage, or network-based storage.

The term “reference information” refers to identification data of a stored document file, such as a file path, a uniform resource locator, a document identifier, or metadata that allows the document file to be accessed or retrieved.

The term “external electronic settlement service” refers to a system or service, separate from the server, that processes financial transactions such as fund transfers or payments based on electronically transmitted requests.

The term “settlement request data” refers to transaction data transmitted to an external electronic settlement service, including at least information representing an amount, a payer, a payee, and transaction conditions.

The term “response result” refers to data received from an external electronic settlement service indicating a status or outcome of a requested financial transaction, including success, failure, or pending states and associated details.

The term “record information” refers to data stored in association with a user, including at least asset information, intention information, plan information, and document data, together with management information that indicates a state of the data.

The term “management information” refers to metadata associated with record information that indicates a management state, such as whether the record information is in an editing state or in a finalized state.

The term “finalized state” refers to a state of record information indicating that the record information has been confirmed by the user as complete and is designated for use in legal, transactional, or sharing processes.

The term “editing state” refers to a state of record information indicating that the record information is provisional and may be modified or updated by further input information from the user.

The term “heir candidate” refers to a person or entity identified in heir candidate information as a potential recipient of assets of the user according to an inheritance distribution plan.

The term “notification information” refers to data generated for informing a user terminal or an heir candidate terminal about availability or contents of official documents, plan information, or related updates, and including at least an indication of the shared item and access information.

The term “heir candidate terminal” refers to an information processing device operated by an heir candidate, such as a computing device having a communication function, a display function, and an input function, and capable of receiving and presenting shared information from the server.

In one embodiment, a server cooperates with one or more user terminals and heir candidate terminals to implement the claimed system. The server includes at least one processor, a main memory, a non-volatile storage device, and a network interface coupled via a bus. The server executes software components including an application server module, a database access module, a generative AI model inference module, a template-based document generation module, and an electronic settlement integration module. The server stores program instructions in the non-volatile storage device, and the processor loads and executes the program instructions in the main memory.

A terminal includes a processor, a memory, a user interface device such as a touch display, and a wireless or wired communication interface. The terminal executes a communication application, such as a messenger-type application, that provides a chat user interface. The communication application runs on an operating system such as a mobile operating system or a desktop operating system. The terminal sends and receives data to and from the server using a secure transport protocol, such as HTTPS over TCP/IP.

The user operates the terminal to launch the communication application and to input information including asset information and intention information through the chat user interface. The terminal converts user keystrokes or voice input into text and packages the text into a message structure including at least a user identifier, a timestamp, and a content field. The terminal transmits the message structure to the server using a communication library such as an HTTP client library.

The server receives the message structure at the application server module. The server authenticates the user identifier using an authentication mechanism such as a token-based authentication scheme. The server parses the message structure into internal data structures including a text string representing the content field. The server stores the raw text and associated metadata in a database system such as a relational database management system or a cloud-based document database.

The server maintains data structures for history information, including previous input information, previously generated plan information, and previously generated document data, indexed by user identifiers. The server merges the newly received text content with the history information to generate context information. The server represents the context information in a structured form such as key-value maps, arrays of asset records, and arrays of heir candidate records.

The server normalizes the context information by applying data transformation procedures. For example, the server converts currency amounts into a standard currency unit, maps free-form asset descriptions into standardized asset categories, and resolves duplicate heir candidate names into unique identifiers. The server writes the normalized context information back into the database in a structured schema, such as tables for assets, heirs, and user intentions, or corresponding collections and documents.

The server generates a prompt sentence for a generative AI model. The server constructs the prompt sentence as a concatenation of textual segments including a system instruction segment, a user profile segment, an asset list segment, an heir list segment, and a latest message segment. The server formats the prompt sentence such that it includes explicit instructions to output an asset management plan, an inheritance distribution plan, and a draft text of a legally effective document. An example of a prompt sentence is:

“User profile: 65-year-old individual with multiple real estate properties and savings. Asset list: House (value: 60,000,000), Savings account (value: 10,000,000), Life insurance (value: 5,000,000). Heirs: Spouse, three children. Latest user message: ‘I want to distribute my real estate equally to my three children and leave my savings to my spouse for living expenses.’ Based on this information, analyze the assets and intentions and generate (1) an asset management plan, (2) an inheritance distribution plan with explicit percentages and conditions, and (3) a draft text of an official will that could be used as a template. Clearly separate the sections as ‘ASSET MANAGEMENT PLAN:’, ‘INHERITANCE DISTRIBUTION PLAN:’, and ‘LEGAL DOCUMENT DRAFT:’.”

The server also generates additional prompt sentences for summarization. For example, the server generates a prompt sentence such as:

“Summarize the following inheritance distribution plan and official will draft in simple language that a non-expert user can understand, in 5 to 7 sentences, preserving all essential conditions and percentages.”

The server passes the prompt sentence to a generative AI model implemented as a deep neural network. In one embodiment, the server implements the generative AI model using a transformer-based architecture with multiple encoder-decoder layers, multi-head self-attention mechanisms, and feed-forward sublayers. The server uses a framework such as a numerical computation framework to define the model graph, including layers for token embeddings, positional encodings, attention computations, and output logits. The server stores trained model parameters, including weight matrices and bias vectors for each layer, in a model storage area.

The server tokenizes the prompt sentence into integer token identifiers using a tokenizer trained with a subword segmentation algorithm. The server then converts the sequence of token identifiers into embedding vectors using an embedding matrix, and the generative AI model processes the embeddings through the transformer layers. Each self-attention layer computes attention weights by applying scaled dot products between query and key vectors, normalizing with a softmax function, and aggregating value vectors. The model modifies internal hidden state vectors according to learned weight matrices and non-linear activation functions such as rectified linear units or other activation functions.

The server performs inference by feeding the tokenized prompt into the generative AI model and iteratively generating output tokens using a decoding strategy such as greedy decoding or beam search. The server stops generation when an end-of-sequence token or a maximal length is reached.

The server decodes the output token sequence back into a text string using the tokenizer.

The server enforces a structured output format by including explicit delimiters in the prompt sentence and by post-processing the generated text. The server searches for markers such as “ASSET MANAGEMENT PLAN:”, “INHERITANCE DISTRIBUTION PLAN:”, and “LEGAL DOCUMENT DRAFT:”. The server splits the text using these markers and extracts the corresponding segments as separate strings. The server then parses the inheritance distribution plan segment to identify heirs, asset identifiers, allocation percentages, and conditions by applying pattern-matching and simple parsing rules, such as regular expressions or rule-based segmentation.

The server transforms the extracted segments into structured data objects and stores them as plan information in the database. The server represents the inheritance distribution plan as records that link asset identifiers to heir identifiers and allocation percentages. The server represents the asset management plan as records that specify management actions, time schedules, and triggers. The server verifies that allocation percentages sum to allowable values and that all referenced assets exist in the asset information, thereby performing consistency checks.

The server selects a format template for a legally effective document according to a ruleset that takes into account jurisdiction, asset types, and user-specific conditions. The server maintains multiple templates for wills, memoranda, and instructions, each template defined as a structured pattern comprising sections and placeholders. The server fills placeholders with data from the plan information and intention information. For example, the server inserts the user's name, addresses of real estate, exact allocation percentages, and special conditions into corresponding template fields.

The server then generates document data as a structured representation of the completed document. The server converts the document data into a document file format such as a portable document format by invoking a document formatting engine. The server embeds metadata including a document identifier, user identifier, creation timestamp, and version information. The server stores the resulting document file in the storage device and records a reference such as a file path or uniform resource locator in the database.

The server provides the reference information to the terminal via the communication application so that the user can access and view the generated document. The terminal receives the reference information, requests the document file from the server or associated storage service, and displays the document in a viewer component on the terminal. The user can review the content and provide additional intention information or corrections via the chat interface, and the server repeats the context generation and plan refinement procedures.

The server integrates the plan information with an external electronic settlement service. The server maps specific entries of the inheritance distribution plan to transaction requests. For example, when the plan specifies that a monetary asset should be transferred to a specific heir upon a trigger condition, the server constructs settlement request data including payer account information, payee account information, an amount, and a transaction type. The server transmits the settlement request data to the external electronic settlement service over a secure protocol and receives a response result indicating success or failure. The server stores the response result associated with the corresponding plan information in the database.

The server maintains record information that includes all asset information, intention information, plan information, and document data. The server adds management information indicating an editing state or a finalized state. The server sets the record information to a finalized state in response to an explicit instruction from the user, such as a confirmation input via the terminal. The server responds to a finalized state by preventing further automatic modifications to the corresponding plan information and document data and by marking such records as eligible for sharing with heir candidates.

The server maintains heir candidate information including contact details for each heir candidate. When a sharing condition is satisfied, such as receipt of a trigger event from an external system or a trusted person, the server generates notification information for each heir candidate. The notification information includes a summary of the plan information relevant to that heir and reference information for the corresponding document files. The server sends the notification information to an heir candidate terminal via a suitable communication channel such as email or messenger messaging. The heir candidate terminal receives the notification information and presents it to the heir candidate for review.

The server improves computer functionality in multiple respects. The server reduces redundant parsing of free-form text by generating and maintaining context information in a structured format and by using prompt sentences that guide the generative AI model to produce machine-parseable sections. As a result, the server decreases the number of post-processing passes required and thereby reduces processing time and processor load. The server improves data management by enforcing a schema for asset records, heir candidate records, and plan records, which allows fast lookup and reliable consistency checks.

The server improves the precision of plan generation by integrating a transformer-based generative AI model with explicit prompt design and template-based post-processing rather than relying solely on static rule sets or purely manual input. The server's use of attention-based neural network layers allows the model to capture dependencies between remote parts of the context information, such as interactions between multiple assets and multiple heirs, which a conventional rule-based engine cannot practically handle at scale. This enables the model to compute complex allocations while maintaining a coherent global plan.

The server trains the generative AI model beforehand using supervised learning on training data consisting of pairs of input contexts and desired outputs. During training, the server computes a loss function such as a cross-entropy loss between predicted token sequences and reference token sequences, and updates model parameters by gradient-based optimization methods such as stochastic gradient descent or adaptive gradient methods. The server may apply data augmentation techniques, such as paraphrasing user intentions or varying asset values within prescribed ranges, to increase robustness. By deploying a model trained with these procedures, the server achieves lower error rates in generating legally coherent drafts and structured plans than prior systems that rely on simpler classification models.

The server employs a non-conventional processing flow by tightly coupling prompt generation, structured extraction, and template-based document composition. Unlike a straightforward automation of human drafting, the server defines algorithmic rules for segmenting outputs, validating percentages, reconciling asset identifiers, and automatically controlling which parts of the output are used for transaction generation. This structured control over generative outputs ensures that only data satisfying internal consistency constraints are propagated to downstream modules, thereby reducing the rate of logical and computational errors.

In another embodiment, the server implements a variant generative AI model with a hybrid architecture combining a transformer encoder with a recurrent decoder, and the server optimizes the architecture parameters such as the number of layers, hidden state dimensions, and attention heads to balance computational cost and accuracy. The server may use different models for planning and summarization tasks, with the planning model configured with more layers and attention heads to handle complex reasoning, and the summarization model configured with fewer parameters for faster response. This modular approach allows the server to allocate hardware resources efficiently and to reduce latency under high load.

In yet another embodiment, the server applies caching mechanisms for prompt sentences and model outputs. When the user makes small modifications to intentions that do not affect asset lists, the server reuses previously computed intermediate representations and only performs incremental updates. This reduces redundant computation inside the generative AI model and lowers the overall inference time, thereby improving responsiveness of the system.

In still another embodiment, the server employs compression and batching techniques for model input. The server aggregates multiple prompt sentences corresponding to different users into batched tensors and executes them in a single inference pass on hardware such as a graphics processing unit or a tensor accelerator. This approach improves throughput of the model inference module and reduces communication overhead between the server processor and the hardware accelerator.

The technical effects achieved by these embodiments include improved processing speed through reduced redundant parsing and batched model inference, improved accuracy of asset management and inheritance distribution plans through attention-based modeling and structured validation, improved data management by maintaining normalized schemas and finalized-state control, and reduced communication load by sharing only finalized and relevant information with terminals. These improvements arise from specific configurations and interactions of server hardware and software, including the generative AI model, the prompt sentence construction, and the data structures for context and plan information, and are not merely a computer implementation of a human mental process.

While specific embodiments have been described, the server may be configured with alternative database systems, alternative neural network architectures, and alternative document file formats, as long as the server performs integration of input information into context information, controlled invocation of a generative AI model via prompt sentences, structured post-processing of analysis results into plan information and document data, and management of finalized records for sharing with heir candidates. The terminal may be implemented as any computing device with a user interface and network connectivity, and the system may be deployed on various network topologies without departing from the scope supported by the claims.

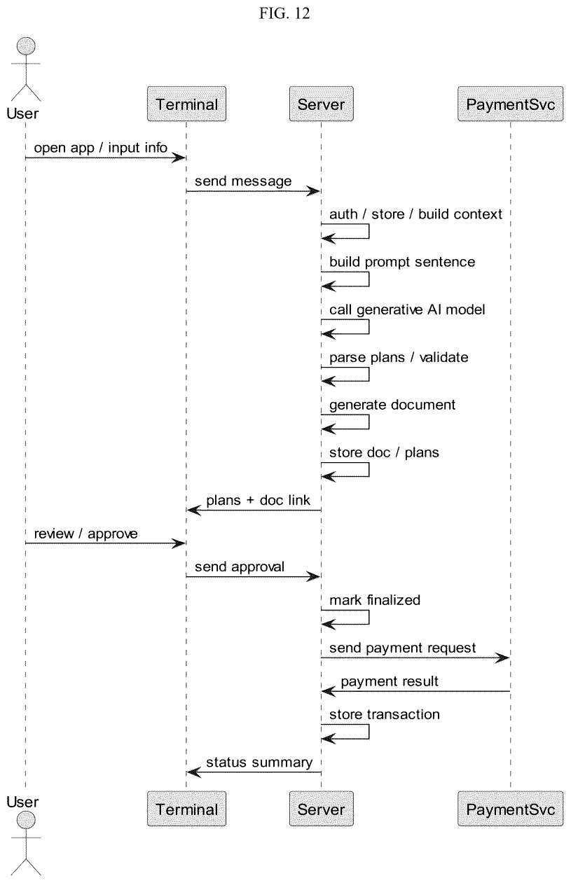

The following describes the processing flow using FIG. 12.

### Step 1

The user operates the terminal to launch the communication application and to open a chat screen with the AI advisor.

Input: No prior data; the user simply activates the application.

Output: The terminal displays an empty or previous chat history and an input field.

The terminal initializes a secure network session to the server by establishing an HTTPS connection and preparing authentication tokens stored in local secure storage.

### Step 2

The user inputs asset information and intention information into the chat interface on the terminal.

Input: User keystrokes or voice input describing assets (for example, houses, savings, insurance) and intentions (for example, how to distribute assets).

Output: The terminal generates a message object including a user identifier, timestamp, and text content.

The terminal converts voice input to text using an operating system speech recognition API when necessary, and the terminal encodes the message object as JSON for transmission.

### Step 3

The terminal transmits the message object to the server over the established HTTPS connection.

Input: The JSON message object containing user identifier, timestamp, and text content.

Output: An HTTP request containing the JSON payload and an authentication header is sent to the server.

The terminal uses an HTTP client library to perform the POST request and waits for an acknowledgment or response.

### Step 4

The server receives and authenticates the incoming request.

Input: The HTTP request with the JSON message and authentication token.

Output: A validated internal representation of the message or an error response in case of authentication failure.

The server verifies the authentication token against stored session data, parses the JSON into an internal data structure, and discards or logs malformed requests.

### Step 5

The server stores the raw input information as part of history information.

Input: The parsed message structure including user identifier, timestamp, and text content.

Output: A new record in a messages table or collection, and updated history information linked to the user.

The server executes a database write operation using a database driver, inserting the message into persistent storage, and updates indexes for efficient retrieval by user identifier and time.

### Step 6

The server retrieves existing history information related to the user.

Input: The user identifier extracted from the message structure.

Output: A set of records including prior messages, previously stored asset information, heir candidate information, intention information, and existing plan information.

The server queries the database using the user identifier as a key, aggregates the returned rows or documents, and holds them in memory as a composite data structure.

### Step 7

The server generates context information by integrating new input with history information.

Input: The newly received text content and the set of history records.

Output: Context information including normalized asset information, heir candidate information, and intention information.

The server performs data aggregation and normalization: the server parses the new text to identify potential asset-related terms, updates or adds asset records, merges heir data if new heirs are mentioned, and reconciles overlapping intention statements into a coherent representation.

### Step 8

The server normalizes numeric values and categories in the context information.

Input: Raw asset records, heir records, and intention statements in semi-structured form.

Output: Normalized asset records with standardized units, categorized asset types, and resolved unique heir identifiers.

The server converts different currencies into a base currency using stored exchange rates, assigns category codes to asset descriptions, and uses matching algorithms to detect duplicate heir entries based on names and relationships.

### Step 9

The server constructs a prompt sentence for the generative AI model based on the context information.

Input: The normalized context information containing asset information, heir candidate information, and intention information.

Output: A single text string forming a prompt sentence that instructs the model to produce an asset management plan, an inheritance distribution plan, and a legal document draft.

The server concatenates textual segments describing the user profile, asset list, heir list, and latest user message, and appends explicit instructions such as “generate an asset management plan” and “separate sections as ASSET MANAGEMENT PLAN, INHERITANCE DISTRIBUTION PLAN, LEGAL DOCUMENT DRAFT.”

### Step 10

The server tokenizes the prompt sentence and prepares model input.

Input: The prompt sentence as a text string.

Output: A sequence of token identifiers and corresponding embedding vectors.

The server uses a tokenizer to split the text into subword tokens, maps each token to an integer identifier, creates an array of these identifiers, and then applies an embedding matrix to generate numeric vectors representing each token.

### Step 11

The server executes inference with the generative AI model.

Input: The sequence of token embeddings representing the prompt sentence.

Output: A sequence of output token identifiers representing the model's response.

The server feeds the embeddings into the transformer-based neural network, where each layer performs attention computations and nonlinear transformations, and the server decodes one output token at a time using a decoding strategy such as greedy search until an end-of-sequence token is produced.

### Step 12

The server decodes and segments the model output into logical sections.

Input: The output token identifiers generated by the generative AI model.

Output: Three text segments: an asset management plan segment, an inheritance distribution plan segment, and a legal document draft segment.

The server converts tokens back into text, searches for markers such as “ASSET MANAGEMENT PLAN:”, “INHERITANCE DISTRIBUTION PLAN:”, and “LEGAL DOCUMENT DRAFT:”, and splits the text at these markers into separate strings.

### Step 13

The server parses the inheritance distribution plan into structured plan information.

Input: The inheritance distribution plan text segment.

Output: Structured records mapping asset identifiers to heir identifiers and allocation percentages or conditions.

The server applies pattern-matching rules to detect asset names, heir names, and numerical percentage values, maps asset names to existing asset records, maps heir names to heir records, and computes any implied values, such as equal shares, to fill percentage fields.

### Step 14

The server parses the asset management plan into structured plan entries.

Input: The asset management plan text segment.

Output: Plan entries specifying management actions, schedules, and triggers for each asset.

The server identifies action verbs (for example, “invest,” “hold,” “sell”), associated asset identifiers, and temporal expressions; the server encodes these items into records with fields such as action type, target asset, amount, starting date, and frequency.

### Step 15

The server validates consistency of the structured plan information.

Input: The structured inheritance distribution records and asset management records.

Output: A validation result and, if successful, a cleaned set of plan information suitable for storage.

The server computes sums of allocation percentages for each asset, checks that the sums do not exceed allowed limits, verifies that every referenced asset exists and is not doubly allocated in conflicting ways, and flags or corrects minor inconsistencies where possible.

### Step 16

The server stores the validated plan information in the database.

Input: The cleaned set of asset management and inheritance distribution plan records.

Output: Database entries in plan-related tables or collections associated with the user identifier.

The server performs insert or update operations, writing each plan entry with version numbers and timestamps, and updating indexes that allow quick retrieval by user identifier and plan status.

### Step 17

The server selects an appropriate legal format template for document generation.

Input: The analysis result, including plan information and contextual metadata such as jurisdiction and asset types.

Output: A template identifier and a corresponding template structure defining sections and placeholders.

The server applies a rule engine that matches conditions, such as “individual user” and “testamentary document,” to a template library and chooses a template with sections like “Preamble,” “Heirs,” “Assets,” and “Distribution Provisions.”

### Step 18

The server fills the selected template with plan information and intention information.

Input: The template structure, the inheritance distribution plan, the asset management plan, and the intention information.

Output: Document data representing a completed legal document in structured form.

The server replaces placeholders in the template with actual data, such as user name, heir names, asset descriptions, and exact distribution percentages, and constructs paragraphs according to template rules.

### Step 19

The server converts the document data into a document file.

Input: The structured document data including text and formatting metadata.

Output: A document file in a chosen document file format, such as a portable document format file.

The server uses a document generation library to layout the text, apply fonts and headings, render sections, and write the resulting binary file to the storage device, while embedding metadata such as document identifier and creation date.

### Step 20

The server stores the document file and generates reference information.

Input: The generated document file and associated metadata.

Output: A file path or uniform resource locator serving as reference information.

The server saves the file to a file system or object storage, records the location and metadata in the database, and marks the document as related to a particular plan version.

### Step 21

The server transmits reference information and plan summaries to the terminal.

Input: The reference information, the plan information, and optionally a short summary generated by an additional prompt sentence.

Output: A response message containing links to the document file and textual descriptions of the plans.

The server packages the information into a JSON response, sends it over HTTPS to the terminal, and logs the time and content of the outgoing message.

### Step 22

The terminal receives and displays the server response to the user.

Input: The JSON response containing document reference information and textual plan summaries.

Output: Updated chat display on the terminal showing the AI advisor's reply and an interactive element such as a button or link to open the document.

The terminal parses the JSON, appends the reply text to the chat history, and initiates a document viewer when the user selects the reference, fetching and rendering the document file if necessary.

### Step 23

The user reviews the plan and document content and optionally issues corrections or approvals.

Input: The visual presentation of the plan summaries and document contents on the terminal.

Output: New user messages indicating corrections, clarifications, or a final approval instruction.

The user types or speaks new instructions, and the terminal packages these as new message objects which are then sent to the server, triggering further iterations of context integration and plan regeneration if needed.

### Step 24

The server marks record information as finalized in response to user approval.

Input: A user message indicating final approval of the current plan and document.

Output: Updated management information for the relevant record information, indicating a finalized state.

The server identifies the current plan and document version, updates corresponding database records to set a finalized flag, prevents subsequent automatic modifications to these records, and logs the finalization event.

### Step 25

The server determines whether to initiate electronic settlement based on the finalized inheritance distribution plan.

Input: The finalized inheritance distribution plan and configuration data indicating which items require electronic settlement.

Output: A set of settlement request data structures for specified monetary assets, or a decision that no settlement is required at this time.

The server scans the plan for entries specifying transfers or scheduled payments, maps these entries to payer and payee account data, and prepares transaction details including amounts and timing.

### Step 26

The server transmits settlement request data to an external electronic settlement service.

Input: The prepared settlement request data including account identifiers, amounts, and transaction types.

Output: Request messages sent to the external service and response results received from the service.

The server calls an application programming interface of the external service over a secure network channel, handles transaction identifiers returned by the service, and parses status codes and messages indicating success or failure.

### Step 27

The server stores the settlement response results in association with the plan information.

Input: The transaction status and details received from the external electronic settlement service.

Output: Updated transaction records linked to the corresponding plan entries in the database.

The server writes transaction logs, including identifiers, timestamps, and statuses, and updates plan entries to reflect completed, pending, or failed transactions.

### Step 28

The server manages heir candidate contact information and prepares notification information for sharing finalized records.

Input: Heir candidate information stored for the user and the finalized record information.

Output: Notification information for each heir candidate, including plan summaries and document references.

The server selects data relevant to each heir, constructs personalized summary text, attaches references to the relevant document files, and encodes this as messages for transmission over email or messaging channels.

### Step 29

The server transmits notification information to heir candidate terminals when a sharing condition is satisfied.

Input: The notification information prepared for each heir candidate and a trigger indicating that sharing is authorized.

Output: Outgoing messages delivered to heir candidate terminals.

The server sends emails or messenger messages containing the notification content and logs delivery attempts and outcomes for audit purposes.

### Step 30

The heir candidate uses an heir candidate terminal to access shared plan information and documents.

Input: The notification messages and document references received from the server.

Output: Display of relevant plan summaries and documents on the heir candidate terminal.

The heir candidate terminal retrieves the referenced document files from the server or storage, renders them on a display, and allows the heir candidate to understand the distribution plan and related instructions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented systems for generating legal documents from user input suffer from several technical limitations in how they acquire, structure, and transform user data into machine-processable representations suitable for automated document generation, particularly when using a generative AI model. In many existing systems, user inputs are handled as unstructured text within generic communication applications, which forces the server to perform costly and error-prone natural language parsing in order to extract key parameters such as identity information, location information, asset information, and successor information. This unstructured processing leads to increased computational overhead, unstable latency, and inconsistent output, thereby degrading the overall performance of the legal-document generation pipeline implemented on the computer system.

Further, in typical implementations, the construction of a prompt sentence for a generative AI model is not systematically linked to a structured representation of the user's data and the target legal context. As a result, the generated prompt often lacks explicit instructions regarding document type, applicable legal domain, document format, and required clauses, which causes the generative AI model to output legal documents with missing sections, incorrect clause structures, or ambiguous legal expressions. This inconsistency requires human review and substantial manual corrections outside the automated pipeline, preventing efficient end-to-end computer processing.

Additionally, known systems do not tightly integrate post-processing of the generative AI model's text output with automatic conversion into a fixed electronic document format. Document layout, typeface, page division, and identification information are frequently determined manually or by separate tools not coordinated with the structured input and prompt design. This fragmented approach makes it difficult for the server to ensure that generated documents consistently conform to predetermined formatting rules and that iterative user edits can be efficiently re-incorporated into the structured data and the subsequent AI-driven regeneration process. Consequently, the interaction between the user terminal and the server often results in redundant data entry, repeated parsing, and non-deterministic document regeneration behavior.

Therefore, there is a need for an improved computer-implemented system and server-side processing mechanism that (i) acquires user information via a structured input interface on a user terminal, (ii) converts the acquired information into structured data, (iii) generates, from the structured data, a prompt sentence configured for a generative AI model with explicit legal and formatting constraints, (iv) performs systematic post-processing and layout control for conversion into a fixed electronic document format, and (v) supports iterative user confirmation and correction with efficient regeneration. Such a system would improve the technical functioning of the underlying computer platform by reducing parsing complexity, stabilizing processing latency, and providing predictable, high-quality legal document outputs.

The specific processing by the specific processing unit 290 of the data processing device 12 in Example 2 is realized by the following means.

The present invention provides a server comprising a processor and a memory storing instructions which, when executed by the processor, cause the processor to control a user terminal to present an input screen through which a user inputs input information including identity information, location information, asset information, and successor information, to transform the input information into structured data, to receive the structured data from the user terminal via a communication protocol, to analyze the structured data to generate a prompt sentence specifying a document creation target, an applicable legal domain, a document format, clauses to be described, and contents of the input information, to input the prompt sentence to a generative AI model, to obtain text data generated by the generative AI model in response to the prompt sentence, to post-process the text data to normalize a body structure, a heading structure, and a clause structure of a legal document corresponding to the structured data, to convert the post-processed text data into a fixed electronic document file format by automatically setting document layout, typeface, page division, and identification information, to transmit the fixed electronic document file to the user terminal for display and iterative user confirmation and correction, and to, after final confirmation by the user, provide the fixed electronic document file in a storable or outputtable form. This enables improved computer-implemented generation and regeneration of legally valid documents with reduced parsing overhead, consistent prompt construction for the generative AI model, stable document formatting, and efficient iterative user interaction within an integrated server-terminal architecture.

The term “user” refers to a human individual or an organizational entity that operates a user terminal to input information, review generated documents, and confirm or correct document content.

The term “user terminal” refers to an electronic device, such as a computing device or communication device, that provides a user interface for data entry, display of documents, and communication with a server over a network.

The term “input information” refers to data provided by the user via the user terminal, including at least identity information, location information, asset information, and successor information, and optionally additional parameters relevant to generation of a legal document.

The term “identity information” refers to information that identifies the user or another subject of the legal document, such as a name, contact details, or similar identification data.

The term “location information” refers to information indicating a geographical place associated with the user or legal document, such as an address, region, or jurisdiction.

The term “asset information” refers to information describing property or rights held by the user or another party, including but not limited to financial assets, tangible assets, and intangible assets.

The term “successor information” refers to information describing one or more persons or entities that are designated to receive, inherit, or succeed to assets or rights under a legal document.

The term “structured data” refers to input information that has been transformed into a predefined data structure, such as key-value pairs, records, or objects, suitable for machine processing without natural language parsing.

The term “communication protocol” refers to a set of rules and procedures used for transmitting data between the user terminal and the server over a communication network, including at least one of a transport protocol and an application-layer protocol.

The term “prompt sentence” refers to a machine-generated natural language instruction or set of instructions constructed from structured data and specifying one or more of a document creation target, an applicable legal domain, a document format, required clauses, and content details, the prompt sentence being provided as input to a generative AI model.

The term “generative AI model” refers to a machine learning model configured to generate text data based on input data, such as a neural network-based language model that produces document content in response to a prompt sentence.

The term “text data” refers to character-based or token-based output generated by the generative AI model in response to a prompt sentence, representing at least part of the content of a legal document.

The term “post-processing” refers to one or more operations applied to text data returned from the generative AI model, including formatting, normalizing, reordering, or supplementing the text to conform to desired document structures and rules.

The term “body structure” refers to an arrangement of main textual sections of a document, including an ordering and grouping of paragraphs or sections that form the substantive content of the document.

The term “heading structure” refers to an arrangement and formatting of titles, headings, and subheadings within a document, used to organize sections and improve readability and navigability.

The term “clause structure” refers to an arrangement, numbering, and internal organization of individual provisions or clauses within a legal document, including their sequence and logical relationships.

The term “legal document” refers to a document having legal significance, such as a contract, will, agreement, declaration, or other formal writing that may be used to establish rights or obligations.

The term “document file format” refers to a digital representation of a document in a specific file type suitable for storage or display, including but not limited to a fixed-layout electronic format.

The term “fixed electronic document format” refers to a document file format in which the layout, fonts, pagination, and overall appearance are deterministically defined and preserved across different viewing environments.

The term “document layout” refers to spatial arrangement parameters of elements in a document, including margins, line spacing, paragraph spacing, alignment, and placement of headings and body text.

The term “typeface” refers to a style of font used to render characters in a document, including settings regarding font family, font size, and emphasis such as bold or italic styles.

The term “page division” refers to the segmentation of a document's content into separate pages, including automatic determination of page breaks based on length, layout, and formatting constraints.

The term “identification information” refers to information embedded in or associated with a document file to uniquely identify the document, such as a document ID, timestamp, or user-related identifier.

The term “storable form” refers to a state of a document file in which the file can be saved to a storage medium, including local storage or network-based storage, for later retrieval.

The term “outputtable form” refers to a state of a document file in which the file can be output from a computer system, including at least one of printing, exporting, transmitting, or sharing via a communication channel.

The term “iterative user confirmation and correction” refers to a process in which a user repeatedly reviews generated document content on the user terminal, inputs corrections or modifications, and causes regeneration of the document based on updated structured data.

The term “server” refers to an information processing apparatus comprising at least a processor and a memory, configured to communicate with user terminals, to process structured data, to interact with a generative AI model, and to generate and provide document files.

The term “processor” refers to one or more hardware-based processing units capable of executing instructions stored in a memory to perform operations such as data analysis, prompt generation, communication, post-processing, and file conversion.

The term “memory” refers to one or more storage devices or storage media configured to store instructions and data used by the processor, including volatile memory and non-volatile memory.

In one embodiment, a server cooperates with one or more terminals operated by users in order to generate legally valid documents using a generative AI model on the basis of structured user input. The server includes at least one processor and at least one memory storing executable instructions. The terminal includes at least one processor, a memory, a display, and one or more input devices such as a touch panel or a hardware keyboard. The server and the terminal communicate over a communication network using a secure communication protocol.

A terminal provides a graphical user interface implemented, for example, as a web application running in a browser or as a native application running on a mobile operating system. The terminal displays input fields for identity information, location information, asset information, and successor information. The terminal records user input in a local data structure, such as an object in main memory, and converts the information into structured data in a key-value format. The terminal then transmits the structured data to the server via a secure HTTPS connection.

A server receives the structured data and stores it in a memory-resident data structure that associates each user session with the corresponding identity information, location information, asset information, and successor information. The server uses a software stack including an operating system, an application framework, and JSON parsing libraries to efficiently transform the incoming data into an internal representation. The server validates the structured data by checking required keys, type constraints, and logical consistency. For example, the server checks that each successor entry includes a name and a relationship attribute, and that each asset entry includes a category attribute.

A server generates a prompt sentence using a deterministic template-based algorithm that is driven by the structured data. The server selects a prompt template associated with a particular document creation target and jurisdiction. The server inserts the structured values into template slots and also generates explicit instructions that constrain the generative AI model. In one embodiment, the server constructs a prompt sentence in plain text as follows:

“The user wants to create a legally valid last will and testament in Japanese. Please act as an expert legal document drafter and generate a complete will that follows standard legal wording and formatting used in Japan. Use clear sections and numbered clauses. Base the content strictly on the following information:
Name of testator: Taro Yamada
Address of testator: 1-2-3 Shinjuku, Shinjuku-ku, Tokyo
Assets: bank accounts, stocks, real estate
Heirs: Hanako Yamada (daughter), Jiro Yamada (son)

Include clauses for identification of the testator, revocation of prior wills, specification of asset distribution to each heir, handling of any remaining assets, and closing sections for date, place, and signature. Output only the final will text, without additional explanations.”

A server inputs this prompt sentence to a generative AI model. In one embodiment, the generative AI model is implemented as a transformer-based neural network that includes a plurality of self-attention layers, feed-forward layers, and embedding layers. The model maintains trainable parameters in the form of weight matrices associated with token embeddings, attention projections, and intermediate activations. The server uses an API client module to serialize the prompt sentence and meta-information such as maximum output length, sampling temperature, and output language constraints into a request to a remote inference service.

A server causes the generative AI model to process the prompt sentence token by token, where each token corresponds to an integer index into a shared vocabulary. The generative AI model computes, in each layer, multi-head attention scores between the current token and all previous tokens, performs weighted summations, and applies non-linear transformations. The model reduces an objective function during training, such as cross-entropy loss between predicted token distributions and ground truth tokens, using a weight update algorithm such as stochastic gradient descent with momentum or adaptive optimization. The server may store information about the training configuration, including a specification of a training dataset of legal texts, the use of regularization techniques such as dropout, and data augmentation methods such as paraphrasing or clause re-ordering for robustness.

A server receives text data from the generative AI model as a sequence of tokens that are decoded into a sequence of characters. The server performs post-processing using a rule-based engine and a structural parser. The server divides the text into sections based on headings, numbers, and legal clause keywords. The server normalizes the clause structure by enforcing a numbering scheme and by inserting missing mandatory headings when they are absent. The server uses deterministic algorithms to align each clause with elements of the structured data so that each asset and each successor is explicitly reflected in at least one clause. This alignment reduces logical omissions and improves accuracy compared to human-crafted documents or naïve text generation.

A server converts the post-processed text data into a fixed electronic document format. In one embodiment, the server uses a document composition engine that transforms the text into a page description format such as PDF. The server sets document layout parameters programmatically, including margin sizes, line spacing, font size, and font family selections appropriate for a legal document. The server computes page division based on these layout parameters and the length of each clause. The server embeds identification information, such as a document identifier, generation timestamp, and hash values of the structured data, into metadata fields of the electronic document.

The server executes these layout and conversion operations using specific libraries running on server hardware, such as a PDF generation library that executes instructions on a central processing unit.

A terminal receives the fixed electronic document file and invokes a display component that renders the document on a screen. The terminal allows the user to zoom, scroll, and navigate by pages. The terminal also provides a control element such as a button to open an editing interface. When the user identifies an error or wishes to change the content, the terminal presents an editing form that is populated with the structured data originally used to create the document. The terminal allows the user to modify the identity information, location information, asset information, or successor information in structured form, rather than editing free-form text.

A server receives the updated structured data from the terminal and determines that the changes require regeneration of the document. The server thereby regenerates a prompt sentence and re-invokes the generative AI model using the updated structured data. The server then repeats the post-processing and document conversion. This cycle enables iterative user confirmation and correction without repeated free-text editing. Because the server avoids unstructured natural language parsing and uses structured data at all stages, the server reduces computational overhead, improves determinism of the generated legal document, and ensures consistency of clause coverage.

A server achieves technical improvement over conventional systems in several ways. First, the server eliminates the need to apply generic natural language understanding pipelines to unstructured chat messages. Instead, the server enforces a structured input representation at the terminal and preserves that structure through prompt construction, model invocation, and post-processing. By avoiding complex parsing and entity extraction on free-form text, the server reduces processor cycles, memory usage, and latency per document generation request. The deterministic mapping between structured data and prompt sentence also improves reproducibility of results and reduces variation between generated documents.

Second, the server uses a prompt construction algorithm that explicitly encodes layout and clause requirements in the prompt sentence. This algorithm includes rules that inject explicit instructions about numbering, presence of revocation clauses, and treatment of residual assets. Human operators typically craft such instructions manually and inconsistently; the server applies these instructions automatically and uniformly. This technical approach improves the precision of machine output and decreases the frequency of missing clauses, thereby reducing the error rate of the legal document content itself.

Third, the server integrates the generative AI model with a domain-specific post-processing pipeline. While the generative AI model generates natural language text using learned statistical associations, the server applies rule-based checks and structural constraints that are derived from the structured data and the legal domain. For example, the server validates whether each successor mentioned in the structured data appears in the generated text and, if not, triggers automatic insertion or regeneration of relevant clauses. This combined architecture of statistical text generation and deterministic structural enforcement achieves higher accuracy and reliability than either technique alone.

Fourth, the server dynamically controls document layout and generates a fixed electronic document format directly from the structured representation and the normalized clause structure. The server does not simply place arbitrary text into a generic template but calculates layout parameters on the basis of clause structure and hierarchy. This integrated layout computation reduces manual formatting operations and ensures that the resulting electronic documents have consistent appearance across different terminals and print devices.

Fifth, the server manages state information for each user session, linking structured data, prompt sentences, AI outputs, and fixed electronic document versions. By maintaining this state as a set of machine-readable records, the server can implement efficient caching and change detection. When the user changes only certain parts of the structured data, the server can regenerate partial document sections or reuse existing sections, which increases processing speed and reduces network bandwidth compared to regenerating an entire document from scratch.

A server thereby improves computer technology itself by providing a specialized data flow and model interaction architecture for legal document generation. The server does not merely automate human drafting steps; instead, the server defines a novel pipeline that couples structured data, generative AI models, and format-specific post-processing in a way that reduces resource consumption and increases accuracy. The technical effect is reflected in faster response times, lower server load, and reduced error rates in the generated content and formatting.

In another embodiment, a server uses a different neural network architecture or a different training method. For example, the server may use a sequence-to-sequence model with attention instead of a transformer model, or may fine-tune a pre-trained language model on a specialized corpus of annotated legal documents. The server may apply a custom loss function that penalizes omission of required clause types in addition to usual next-token prediction errors. The server may also incorporate additional features into the model input, such as explicit tags for asset categories or jurisdictional codes, to guide clause selection. These variations still rely on the same technical principle of structured data-driven prompt construction and rule-based post-processing.

In another embodiment, a terminal is implemented as a stand-alone computing device that executes a local inference engine. The terminal stores a compact version of the generative AI model and executes forward passes on a local processor, such as a graphics processing unit or a neural processing unit. The terminal maintains structured data in local memory and performs at least part of the prompt construction and post-processing locally, while the server performs storage, logging, or additional verification. This distributed configuration can reduce communication load and latency for users with limited network connectivity, while still maintaining consistency of structured data and document layout.

In still another embodiment, a server supports multiple document types and jurisdictions by storing a repository of template definitions and rule sets. The server selects a template definition based on user-provided location information and a document type selection. Each template definition includes a mapping from structured data keys to clause patterns, a set of mandatory clause types, and a default layout configuration. The server applies these template definitions when building prompt sentences, when validating AI output, and when composing the fixed electronic document. By representing this information as machine-readable records, the server enables rapid adaptation to new document types and jurisdictions without reprogramming.

A user operates the system by interacting with the terminal, reviewing generated documents, and instructing regeneration when necessary. The user benefits from the improved technical performance because documents are generated more quickly and consistently than in conventional systems. The user is not required to know legal drafting conventions or formatting details; the server encapsulates this specialized knowledge into structured rules and neural network parameters and applies them automatically through the described architecture.

Through these embodiments, the server, the terminal, and the generative AI model cooperate in a specific, constrained manner that improves the technical functioning of the computer system as a whole. The structured data handling, specialized prompt sentence construction, model interaction, rule-based post-processing, and integrated layout control collectively produce a practical and technically improved solution for generating legally valid documents on a computing platform.

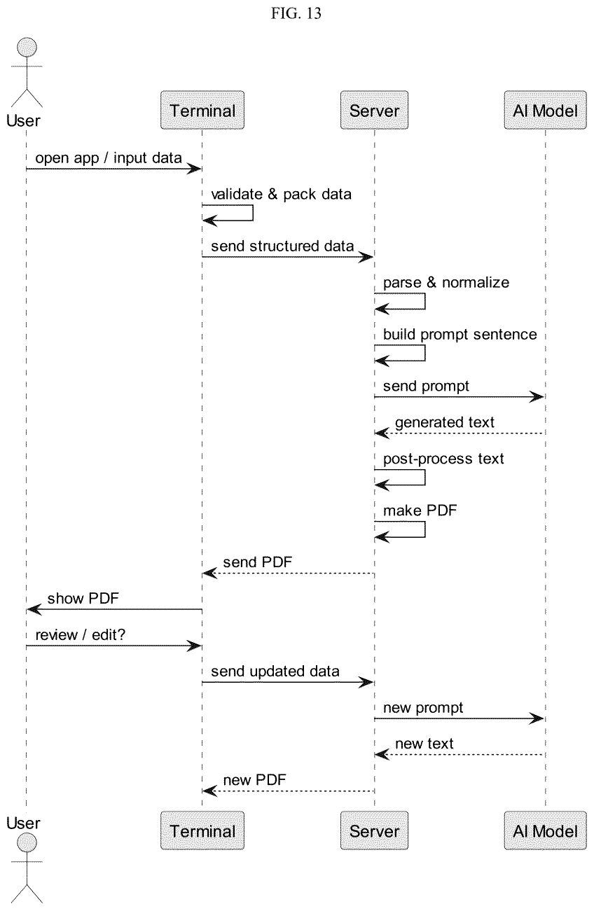

The following describes the processing flow using FIG. 13.

### Step 1

The user operates the terminal to open an application screen for legal document creation. The terminal displays input fields for identity information, location information, asset information, and successor information.

Input: User actions on the terminal UI (touch, keyboard input) and empty input fields.

Processing: The terminal executes UI rendering logic to draw text boxes, labels, and buttons using a graphical framework (for example, a browser engine or a native UI toolkit). The terminal allocates data structures in memory (for example, objects or records) to hold user-entered values. As the user types, the terminal updates these data structures.

Output: A populated in-memory representation of user input on the terminal, including identity, location, asset, and successor fields.

### Step 2

The terminal validates the user's input locally before transmission.

Input: The in-memory representation of user input (strings for names and addresses, lists for assets and successors).

Processing: The terminal runs validation functions that check for required fields, permissible character sets, and value formats (for example, non-empty name field, location string length within limits). The terminal may perform simple calculations, such as counting successors or assets, and flags inconsistencies (for example, zero successors). If errors are detected, the terminal updates the UI to display error messages.

Output: Either (i) corrected in-memory structured input that passes validation, or (ii) error status and updated UI messages instructing the user to correct the input.

### Step 3

The terminal converts the validated user input into structured data suitable for transmission.

Input: Validated in-memory input objects containing identity, location, asset, and successor information.

Processing: The terminal serializes the objects into a structured representation such as a key-value map. The terminal may assign standardized keys (for example, “identity. name”, “location. address”, “assets[]”, “successors[]”). The terminal then transforms the map into a text-based structured format using a serialization library. The transformation includes encoding strings into a byte sequence and, optionally, compressing or encoding the data for network transmission.

Output: A structured data payload ready to be sent to the server, associated with a user session identifier.

### Step 4

The terminal securely transmits the structured data to the server.

Input: Structured data payload and server endpoint information.

Processing: The terminal establishes or reuses a secure network connection using a transport layer security protocol. The terminal constructs a network request message with headers and the serialized payload as the message body. The terminal then invokes the operating system's networking stack to send the message over the network, and starts a timer to track the request latency.

Output: A network message containing structured user data sent to the server, and an internal state indicating that the terminal is awaiting a response.

### Step 5

The server receives and parses the structured data from the terminal.

Input: The network message containing the serialized structured data.

Processing: The server's communication module terminates the secure connection and reads the message body from an input buffer. The server invokes a parsing function to decode the serialized payload into a server-side data structure such as an in-memory object tree. The server verifies that all required keys are present and that data types are correct. The server logs the receipt event with a timestamp and session identifier.

Output: A validated server-side structured data object representing the user's identity, location, asset, and successor information.

### Step 6

The server normalizes and enriches the structured data.

Input: The parsed structured data object.

Processing: The server performs normalization by trimming whitespace, converting character encodings to a standard form, and mapping synonyms or variants of asset categories to canonical categories. The server may derive additional fields, such as counting total assets or categorizing successors based on relationship attributes. The server computes these derived values using straightforward algorithms such as counting, grouping, and simple rule-based mappings.

Output: A normalized and enriched structured data object that is ready for prompt construction.

### Step 7

The server generates a prompt sentence for the generative AI model.

Input: The normalized structured data and metadata specifying the document type and jurisdiction.

Processing: The server selects a prompt template from a repository based on document type and legal domain. The server substitutes structured data values into placeholder positions inside the template. The server also appends explicit instructions regarding structure, clause types, and formatting. The generation algorithm concatenates literal strings and encoded field values, and performs basic text operations such as line breaks insertion and numbering.

Output: A fully constructed prompt sentence in text form that describes the document creation task and lists all relevant user data.

### Step 8

The server sends the prompt sentence to the generative AI model and requests text generation.

Input: The prompt sentence and model configuration parameters (for example, maximum output length, temperature).

Processing: The server serializes the prompt and configuration into a request for the generative AI model. The server sends this request to an inference engine and awaits a response. The server maintains a correlation identifier to match the model response with the initial user request. The server may record metrics such as start time to measure model inference latency.

Output: A model request in a predefined format transmitted to the generative AI model, and an internal state waiting for generated text data.

### Step 9

The server receives generated text data from the generative AI model.

Input: A response message from the generative AI model containing generated token sequences.

Processing: The server decodes tokens into characters using a vocabulary mapping. The server concatenates the sequence of tokens into a single text string. The server checks for truncation indicators or error codes from the model and, if necessary, may issue a follow-up request or mark the response as incomplete. The server then stores the raw generated text for further processing.

Output: A raw legal document text string produced by the generative AI model in response to the prompt sentence.

### Step 10

The server post-processes the generated text to enforce legal and structural constraints.

Input: The raw generated legal document text string and the normalized structured data.

Processing: The server scans the text for headings, numbered clauses, and key legal terms. The server applies parsing rules that detect section boundaries (for example, lines starting with numbers or specific keywords). The server constructs a hierarchical representation of the document with nodes for sections and subclauses. The server cross-references each asset and successor in the structured data against this representation to verify that each appears in at least one clause. When a missing reference is detected, the server may insert a supplementary clause or flag the text for partial regeneration.

Output: A structured representation of the legal document with validated coverage of user data and a normalized clause and heading structure.

### Step 11

The server converts the structured document representation into a fixed electronic document format.

Input: The structured representation of the legal document and layout configuration parameters.

Processing: The server feeds the text content and structural annotations (such as headings and clause numbers) into a document composition engine. The engine assigns page layout parameters, including margins, line spacing, fonts, and page breaks, and calculates positions for each line of text. The server generates the fixed electronic document (for example, in PDF format) by encoding text, layout, and embedded metadata (such as a unique document identifier and timestamp) into a binary file structure.

Output: A fixed electronic document file that faithfully represents the structure and content of the generated legal document.

### Step 12

The server transmits the fixed electronic document to the terminal.

Input: The fixed electronic document file and the user session identifier.

Processing: The server constructs a network response containing the document file as payload and appropriate headers indicating content type and file name. The server uses a secure network protocol to send the response back to the terminal. The server updates server-side logs to record completion of the document generation, including generation time and file identifier.

Output: A response message delivered to the terminal that contains the fixed electronic document file.

### Step 13

The terminal receives and displays the fixed electronic document to the user.

Input: The response message from the server containing the fixed electronic document.

Processing: The terminal reads the binary payload, stores it temporarily in memory or local storage, and invokes a display component capable of rendering the fixed electronic document. The terminal interprets page layout information, draws text and any graphical elements on the screen, and initializes user interface controls such as scroll bars and zoom controls.

Output: A rendered view of the fixed electronic document on the terminal display, ready for user inspection.

### Step 14

The user reviews the document and initiates corrections if needed.

Input: The displayed document content and the user's assessment of correctness.

Processing: The user reads through the document and compares the clauses with their intentions and data. If the user identifies discrepancies or wants to adjust details, the user activates an edit function on the terminal. The terminal then retrieves the associated structured data and reopens the input interface, pre-filled with the current values.

Output: Either user acceptance of the document as final, or updated structured data edits initiated for another generation cycle.

### Step 15

The server regenerates the document based on updated structured data.

Input: Updated structured data transmitted from the terminal after user edits.

Processing: The server repeats the sequence of data normalization, prompt sentence construction, generative AI model invocation, post-processing, and fixed document generation, but now using the updated values. The server may reuse portions of the existing structured document representation that remain unchanged, reducing computation where possible.

Output: A revised fixed electronic document that reflects the user's corrections and preserves the standardized structure and format.

### Step 16

The user finalizes, stores, or outputs the completed document.

Input: The final fixed electronic document displayed on the terminal.

Processing: The user commands the terminal to store the file locally, upload it to a storage service, or send it to a printer. The terminal transfers the file to the selected storage medium or output device using appropriate communication protocols. The terminal may also display confirmation messages and provide access to the file for later retrieval.

Output: A stored or physically printed version of the finalized legal document, along with a completed state for the document generation session.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented document generation and advisory systems mainly focus on converting user input into static text templates or simple rule-based outputs. Such systems suffer from several technical limitations.

First, existing systems generally treat user input as flat, unstructured text and do not robustly transform it into structured data models that can be reused across multiple procedures and document types. As a result, servers must repeatedly parse similar inputs, leading to redundant computations, higher processing latency, and increased memory access overhead.

Second, conventional systems are not configured to integrate emotion analysis as a first-class signal in the core processing pipeline. User sentiment, when it is considered at all, is typically handled at the presentation layer only, without being fed back into the document-generation logic itself. This separation results in suboptimal prompt construction for generative models, inefficient use of computational resources, and increased interaction rounds between the user terminal and the server.

Third, known systems that employ generative AI models usually submit simple, context-poor prompts. These prompts do not combine (i) normalized, structured representations of user asset and intent data with (ii) machine-interpretable emotion states. Consequently, the generative AI model must infer missing context from ambiguous text, which can lead to unstable output quality, unnecessary model invocations, and higher compute consumption.

Fourth, conventional architectures often require separate subsystems or manual steps to convert generated text into secure, distributable legal documents, to manage encryption for designated recipients, and to perform external payment processing. The lack of an integrated control flow increases the number of network round trips, complicates error handling, and degrades the overall throughput and reliability of the server.

Accordingly, there is a need for an improved computer-based system and server-side processing method that:
(1) efficiently converts raw user messages into reusable structured data;
(2) integrates emotion analysis into the core control logic to influence prompt generation and response selection;
(3) programmatically composes optimized prompt sentences for a generative AI model based on both structured data and emotional state; and
(4) in a single, coordinated pipeline, generates legally valid official documents, converts them into a document format, encrypts them for specific parties, coordinates electronic payment, and interacts with external communication and service systems.

Such an improved configuration can reduce redundant parsing, lower latency, improve determinism and quality of generated legal documents, and provide a more efficient, robust server-side workflow than conventional systems.

The specific processing by the specific processing unit 290 of the data processing device 12 in Application Example 2 is realized by the following means.

The present invention provides a server comprising a processor and a memory storing instructions which, when executed by the processor, cause the processor to receive information input by a user via an information processing device through a communication application, analyze the received information to generate structured data representing asset information and user intentions, perform emotion analysis on the received information to determine an emotional state of the user, generate a prompt sentence for a generative AI model based on the structured data and the emotional state, input the prompt sentence to the generative AI model to obtain response information including at least one of a legal document text and an advisory text, adjust a content and an expression style of the response information in accordance with the emotional state, generate text data of an official document having legal validity based on the response information, convert the text data into document-format data, encrypt the document-format data and transmit the encrypted document-format data to designated related parties in association with corresponding decryption information, execute an electronic payment process related to the document-format data in cooperation with an external payment processing device, and provide, on the communication application, an interactive support interface to present the response information and the document-format data to the user. This enables the server to implement an integrated, computer-technical pipeline in which user messages are transformed into structured and emotion-aware prompt sentences, generative AI outputs are deterministically converted into secure, legally valid official documents, and encryption, targeted distribution, and external payment processing are orchestrated by a single optimized control flow, thereby improving processing efficiency, reducing latency, enhancing robustness of document generation, and increasing effective utilization of computational resources compared to conventional systems.

The term “information processing device” refers to an electronic apparatus configured to execute programs, process input data, and communicate with external systems, including but not limited to a personal computer, a mobile terminal, a tablet device, or any other computing device operated by a user.

The term “communication application” refers to software executed on an information processing device that provides a user interface for exchanging messages or data with a remote system over a communication network, and includes, for example, messaging applications, chat applications, web-based chat interfaces, or similar communication software.

The term “user” refers to a person or entity that operates an information processing device to input information, receive output, and interact with the system via the communication application.

The term “processor” refers to one or more hardware processing units, such as a central processing unit, a microprocessor, or a processing core, configured to execute instructions stored in a memory to perform data processing and control operations of the server.

The term “structured data” refers to data that has been transformed from raw user input into a machine-interpretable representation with predefined fields or attributes, such as a data record or hierarchical data object, including identifiers for asset information, user intentions, and related parameters.

The term “asset information” refers to data describing property or resources held by a user, including, for example, real property, financial holdings, securities, deposits, insurance interests, or other economic interests represented in a structured form.

The term “user intentions” refers to data indicating the user's wishes, preferences, or directives regarding handling of assets or procedures, such as creation of a will, execution of a funeral procedure, or distribution of property to designated parties.

The term “emotion analysis” refers to processing performed on user input data to determine an emotional state of the user by applying sentiment analysis, tone detection, or similar emotion recognition techniques based on natural language processing or other computational methods.

The term “emotional state” refers to a classification or parameter set representing an estimated affective condition of the user, such as anxiety, sadness, neutrality, relief, or other emotional categories derived from emotion analysis.

The term “generative AI model” refers to a computational model implemented by one or more processors that is trained using machine learning techniques to generate text or other content in response to input data, and that produces output such as legal document text or advisory text based on a prompt sentence.

The term “prompt sentence” refers to a sequence of machine-interpretable natural language tokens or similar instruction data that is input to the generative AI model to specify a generation task, context, and constraints, and that is constructed from the structured data and the emotional state.

The term “response information” refers to one or more pieces of data output from the generative AI model in response to a prompt sentence, including at least one of a legal document text, an advisory text, or auxiliary explanatory content.

The term “official document” refers to a document configured in a form suitable for use in a legal or formal procedure, and that is intended to have legal validity when executed or otherwise completed in accordance with applicable rules.

The term “legal document text” refers to textual content generated or refined by the generative AI model and configured to express legal rights, obligations, or distributions of property in a format appropriate for a legal or formal document.

The term “advisory text” refers to textual content generated by the generative AI model that provides explanations, recommendations, or guidance to the user, and that may accompany or supplement a legal document text.

The term “text data” refers to information representing characters, symbols, or words in a machine-readable form, including a legal document text or advisory text that has not yet been converted into a final document format.

The term “document-format data” refers to data representing a document in a structured output format suitable for presentation, storage, or distribution, such as a page description format, a portable document format, or another standardized document representation.

The term “encrypt” refers to performing a transformation on data using a cryptographic algorithm and a key so that the data is converted into a form that is unintelligible without corresponding decryption information.

The term “decryption information” refers to information required to restore encrypted data to its original form, including, for example, a cryptographic key, a password, or related parameters necessary for a decryption algorithm.

The term “designated related parties” refers to one or more recipients identified by or for the user, such as heirs, beneficiaries, or other persons or entities having a designated relationship to the user or the generated document, and to whom the document-format data or associated decryption information is to be transmitted.

The term “external payment processing device” refers to a computer system or service operated by a payment service provider that is configured to process electronic payment transactions, including authorization, capture, and settlement of fees associated with the document-format data.

The term “electronic payment process” refers to a sequence of operations for transferring monetary value using electronic communication, including creating a payment request, receiving payment credentials, obtaining authorization, and recording a payment result.

The term “interactive support interface” refers to a user interface presented via the communication application that enables bidirectional exchange of messages or commands between the user and the server, and that dynamically displays response information, document summaries, or status updates during a session.

The term “communication means” refers to hardware and software components configured to transmit and receive data between the server, the information processing device, and external systems, and includes, for example, network interfaces, communication protocols, and application-level messaging services.

The term “inheritance-related parties” refers to persons or entities designated by the user to receive rights or interests in the user's property upon an inheritance event, and that are recipients of document-format data related to inheritance or succession.

The term “funeral procedure” refers to a sequence of operations or arrangements related to memorial or disposal services following a user's death, including planning, coordination, and communication with service providers.

The term “property inheritance procedure” refers to a sequence of operations or processes for transferring ownership or control of assets from the user to designated parties, including preparation of agreements, notifications, and coordination with relevant institutions.

The term “external service provider” refers to an organization or system outside of the server that performs a service related to the generated document or procedure, such as a ceremonial service provider, a financial institution, or a legal professional system.

The term “related party” refers to an individual or entity identified in association with the user or the generated documents, including but not limited to heirs, beneficiaries, agents, legal representatives, or other stakeholders designated by the user.

The term “server” refers to one or more computing devices configured to host the processor, memory, and associated software modules that implement the receiving, analyzing, generating, encrypting, transmitting, payment processing, and interface-providing functions described herein.

In one embodiment, a server implements the claimed system by executing a plurality of software modules on one or more hardware processors. The server includes at least one central processing unit and a main memory, and is connected to a communication network via a network interface. The server cooperates with one or more terminals operated by users, where each terminal is implemented, for example, as a smartphone, a tablet device, or a personal computer executing a communication application such as a messenger application or a web-based chat application.

The server executes a backend application implemented, for example, using a web framework such as a server-side scripting runtime and an HTTP server library. The server further executes a database management system, such as a document-oriented database or a cloud-based datastore, to persist user data and structured records. The server additionally accesses external services, such as a natural language processing API for emotion analysis, an external payment processing service, and an email or messaging gateway, by issuing requests through the network interface.

The terminal executes the communication application that renders a conversational user interface on a display and captures user input via a keyboard, touch interface, or speech-to-text module. The terminal transmits textual messages and associated metadata to the server over a secure communication channel, for example, an HTTPS connection. The terminal receives response messages, document links, and status notifications from the server and presents them to the user.

The user operates the terminal to input information in natural language, including descriptions of asset information, intentions regarding distribution of property, preferences for funeral procedures, and instructions for generating or transmitting legal documents. The user reads the advisory text and preview information presented on the terminal, and optionally confirms payments or authorizes distribution of generated documents to designated related parties.

In one concrete embodiment, the server stores and executes a set of software modules including: a message reception module, a parsing and structuring module, an emotion analysis integration module, a prompt-generation module, a generative AI client module, a response post-processing module, a document-format conversion module, an encryption and distribution module, and a payment integration module. The server stores these modules as executable instructions in the memory and loads them into the processor as needed.

The server uses the message reception module to obtain a raw user message and associated user identifiers from the communication application. The server uses the parsing and structuring module to transform the unstructured text into structured data. For this purpose, the server applies rule-based tokenization, part-of-speech tagging, and entity recognition algorithms. The server can implement these algorithms with a natural language processing library, such as a statistical or neural-network-based parser, and customized dictionaries for domain-specific terms related to assets, heirs, and legal procedures.

The server converts the recognized entities and their relationships into a structured representation, for example, by instantiating an internal data object comprising fields such as asset_type, asset_location, monetary_amount, currency, beneficiary_name, and distribution_ratio. The server stores this structured data in the database under a user-specific record. Because the server normalizes diverse user expressions into a uniform data schema, the server avoids repeated ad hoc parsing for subsequent operations and thus reduces CPU usage and memory bandwidth for repetitive tasks.

The server uses the emotion analysis integration module to extract an emotional state of the user from the received message. In one embodiment, the server submits the user text to an external natural language sentiment analysis API. The external API computes vector representations of the input sentences and applies a classification model to output emotion scores for categories such as “anxiety”, “sadness”, “confidence”, and “neutrality”. The server receives these emotion scores and transforms them into an internal emotional state representation, for example, by mapping continuous scores into discrete levels such as “high anxiety”, “moderate anxiety”, and “neutral”.

In another embodiment, the server directly executes an emotion classifier implemented as a neural network. The server stores pre-trained parameters of a recurrent neural network or a transformer-based sequence classifier in the memory. The server converts the user message into token indices, applies an embedding layer, and processes the resulting vectors through multiple layers of self-attention or recurrent units. The network outputs a probability distribution over predefined emotion labels. The server selects the label with highest probability as the emotional state and records it together with a confidence score. The server thereby eliminates the need for manual labeling by human operators and achieves consistent, low-latency emotion detection at machine speed.

The server uses the prompt-generation module to construct a prompt sentence for a generative AI model based on both the structured data and the emotional state. The server maintains prompt templates stored in the memory. These templates are not static phrases; instead, the server dynamically fills placeholders with structured data fields and emotion-based instructions. For example, the server may generate a prompt sentence such as:

“You are a legal document assistant. Generate a legally valid will for the following user. Use simple and reassuring language because the user is anxious. The user has a house in one city, a bank deposit of a specified amount, and shares in a particular company. The user wants to distribute these assets equally among the user's children. Output a complete will text suitable for conversion into a portable document.”

The server can also generate a different prompt sentence for an inheritance agreement, such as:

“The user has three children and wants to divide the estate equally. Generate an inheritance distribution agreement in a specified jurisdiction, using clear and respectful language. Include clauses describing each asset, each share, and signatures of all heirs.”

The server may further generate a prompt sentence for advisory text, such as:

“The user wrote: ‘I am worried about the funeral arrangements.’ The detected emotion is anxiety.

Generate an empathetic and reassuring reply that explains what information the user should provide next, and outline the main steps of arranging a small family-only funeral.”

The server thereby uses a non-conventional, structured approach to prompt composition. Instead of passing entire raw dialogues to the generative AI model, the server compresses relevant facts into explicit fields and injects emotion-aware instructions. This reduces ambiguity and allows the generative AI model to converge to appropriate outputs using fewer tokens and fewer model invocations, which in turn reduces network traffic and computational load.

The server uses the generative AI client module to invoke a generative AI model implemented on an external or internal compute system. In one embodiment, the generative AI model is a transformer-based neural network with multiple encoder-decoder layers, self-attention mechanisms, and learned token embeddings. During training, a large text corpus including legal documents, advisory writings, and conversational text is used. The server or a training environment minimizes a sequence prediction loss function, such as cross-entropy, by adjusting the network weights via gradient descent. The training process may use mini-batch optimization, adaptive learning rate algorithms, and regularization techniques. Inference on the deployed server is performed by loading the trained weights into the generative AI model and performing forward propagation only, which allows the server to obtain text completions based on the prompt sentence.

The server sends the prompt sentence to the generative AI model and sets control parameters such as maximum output length, sampling temperature, and top-k or top-p filtering thresholds. The generative AI model returns a sequence of tokens representing the generated text. The server decodes these tokens into a character string, which constitutes either a draft legal document text or advisory text. By carefully controlling sampling parameters and providing structured prompt content, the server reduces the likelihood of legally inconsistent or incomplete clauses and decreases the need for repeated generation attempts.

The server uses the response post-processing module to refine the generated text. The server can apply template-based checks for required clause patterns, such as presence of identification of parties, enumeration of assets, allocation rules, and signature blocks. If some parts are missing or ambiguous, the server constructs a secondary prompt sentence that instructs the generative AI model to revise the text. For example, the server may generate:

“Here is a draft will. Check whether all assets are clearly listed and whether each clause is understandable for a non-expert. If needed, rewrite the text to be clearer, but keep it legally valid. The user is anxious, so keep the tone supportive.”

The server then sends the draft text along with this secondary prompt to the generative AI model and receives a corrected or clarified version. This iterative, machine-controlled refinement process enables the server to achieve higher document accuracy and readability than an unstructured, single-pass generation approach.

The server uses the document-format conversion module to convert the finalized legal document text into document-format data, such as a portable document format file. The server invokes a document rendering library executed on the same processor, which lays out the text into pages, applies fonts and margins, and embeds metadata such as creation date and user identification. The server writes the resulting binary data to a storage device, such as a local disk or a network-attached storage system, and stores a reference to the file in the database. By performing conversion within the same controlled pipeline, the server reduces round-trips to external tools and avoids manual, error-prone steps.

The server uses the encryption and distribution module to secure the generated document. The server generates a cryptographic key, for example, a symmetric key under an advanced encryption standard algorithm, and applies block encryption to the document-format data. The server may also use public-key cryptography to encrypt the symmetric key individually for each designated related party.

The server stores mapping information linking the encrypted document to the encrypted keys and the identifiers of heirs or other related parties.

The server uses the communication means to distribute the encrypted document-format data and associated decryption information. The server integrates with an email sending library or a messaging service API to transmit messages containing document access links or attachments to the designated related parties. The server sends the decryption key or password via a separate communication channel, thereby reducing the risk of unauthorized access. The server logs each transmission and any subsequent access events to maintain an auditable history.

The server uses the payment integration module to coordinate an electronic payment process. The server invokes an external payment processing device via an application programming interface, creating a payment session associated with the generated document and the required fee. The server receives a payment URL and forwards it to the terminal. After the user completes the payment on the external payment processing device, the server receives a payment confirmation via a webhook, verifies the authenticity of the notification, and updates the status of the document to indicate that the document is paid and finalized. By tightly integrating payment status with document generation and distribution, the server prevents premature release of documents and avoids redundant manual checks.

In one specific use case, the user inputs: “I want to create a will. My assets are a house in Tokyo, ten million yen in bank deposits, and five hundred shares of company X. I want everything to go equally to my two children.” The server normalizes the asset information, determines that the user intends to create a will and that the emotional state corresponds to moderate anxiety, and generates the following prompt sentence:

“You are a legal document assistant. Generate a legally valid will in English for the following user. Use simple and reassuring language because the user is anxious. The user has a house in a specified city, a bank deposit of ten million yen, and five hundred shares of a company. The user wants all assets to be inherited equally by two children. Output a complete will text suitable for conversion into a portable document.”

The generative AI model outputs a full will text with clauses describing the testator, the assets, the equal distribution to two children, and signatures. The server converts this text into a document-format data file, encrypts it, and prepares it for distribution.

In another use case, the user inputs: “Please prepare an inheritance distribution agreement so that my three children receive equal shares of my estate.” The server constructs a prompt sentence:

“The user has three children and wants to divide the estate equally. Generate an inheritance distribution agreement in the relevant jurisdiction, using clear and respectful language. Include clauses for each asset, each share, and signatures of all heirs.”

The generative AI model returns an agreement text. The server formats, encrypts, and distributes this agreement to inheritance-related parties as described above.

In still another use case, the user inputs: “I am worried about the funeral arrangements.” The server detects a high level of anxiety and generates a prompt sentence:

“The user wrote: ‘I am worried about the funeral arrangements.’ The detected emotion is anxiety. Generate an empathetic and reassuring reply that explains what information the user should provide next, and outline the main steps of arranging a small family-only funeral.”

The generative AI model outputs an advisory text that explains the necessary steps and reassures the user. The server sends this text back to the terminal, where the terminal displays it in the user interface.

From a technical perspective, the described configuration improves computer technology in multiple ways. Because the server converts unstructured user input into structured data and emotion states, the server can construct compact, information-rich prompt sentences that reduce the length of input sequences to the generative AI model. This reduction decreases the computational load for both the generative AI model and the server's network subsystem, thereby lowering latency and resource consumption. Additionally, by maintaining persistent structured records, the server can reuse previously extracted asset and intention data across multiple documents and sessions, avoiding repeated parsing and significantly improving processing efficiency.

Further, the integration of emotion analysis into the core control logic is not a mere presentation adjustment. The server uses emotion states as features in the prompt-generation algorithm and response-selection logic, altering not only surface wording but also which clauses and explanatory sections are generated. This leads to fewer back-and-forth messages between the user and the server and a reduction in overall network traffic and processing cycles, which in turn is a measurable technical improvement over conventional stateless chat systems.

Moreover, the server executes a deterministic, machine-controlled pipeline that coordinates generative AI-based text generation with document-format conversion, cryptographic encryption, and external payment processing. This tight integration reduces the number of independent subsystems and manual interventions typically required in traditional workflows. As a result, the server reduces error rates, accelerates end-to-end document processing, and improves the reliability of document delivery, which are specific improvements in the functioning of the overall computer system.

Alternative embodiments are possible. In one variation, the server executes the generative AI model locally on a graphics processing unit or tensor processing unit, instead of accessing an external model provider. The server stores the model parameters in local memory and uses a model execution engine to perform inference. This reduces dependency on external services and can further reduce communication latency. In another variation, the server uses a different neural network architecture, such as a sequence-to-sequence model with an encoder-decoder structure and attention mechanism, but still uses the same structured data and prompt-generation principles.

In yet another embodiment, the server uses a hybrid rule-based and generative approach. The server first applies deterministic rules to ensure the presence of mandatory legal elements, and then uses the generative AI model to fill in optional explanatory parts and to adapt the tone based on emotion states. This hybrid approach ensures legal completeness while still benefiting from the generative flexibility.

The server may also adjust model parameters and prompt content based on historical performance data. For example, if the server observes that certain prompt structures result in fewer user corrections or fewer generation retries, the server can assign higher weights to such templates. This feedback mechanism allows the server to improve generation quality and speed over time.

Because the embodiments described above define specific data structures, control flows, and algorithmic components implemented by concrete computing hardware, the system does more than merely automate a business process. The system improves the efficiency, reliability, and technical functioning of the underlying computer network and generative AI infrastructure by optimizing prompt composition, integrating emotion-based control signals, and unifying document transformation, security, and payment processes into a single coordinated pipeline.

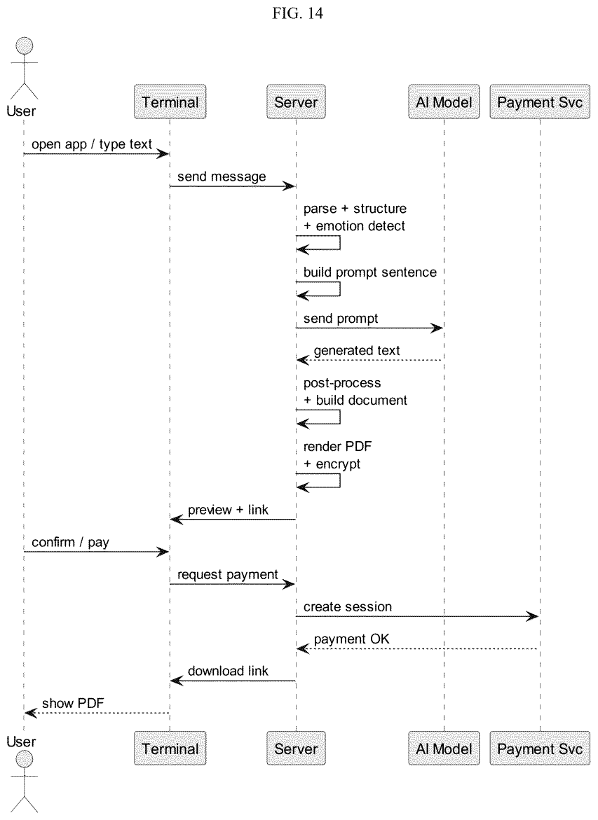

The following describes the processing flow using FIG. 14.

### Step 1

User operates the terminal to launch a communication application and open a chat session.

User inputs natural language text describing assets, intentions, and requests (for example, “I want to create a will” or “I am worried about the funeral arrangements”) into an input field.

Input: raw user text and basic metadata (user ID, timestamp) at the terminal.

Output: a message object (including text, user ID, timestamp) prepared for transmission.

Terminal packages the message object into a request (for example, an HTTPS POST to the server's API endpoint) and transmits it over the network to the server.

### Step 2

Server receives the incoming request from the terminal through the network interface.

Server validates authentication tokens, checks message integrity, and extracts the message body.

Input: HTTP request containing user text, user identifier, and context identifiers (session ID, conversation ID).

Output: a validated raw text string and associated identifiers stored in memory.

Server writes the raw text and metadata into a message log in a database and forwards the text to a parsing and structuring module for further processing.

### Step 3

Server uses the parsing and structuring module to transform the raw text into structured data.

Server applies tokenization, part-of-speech tagging, and entity recognition to detect asset-related terms, person names, numerical amounts, and intent-related phrases.

Input: validated raw text and user identifier.

Output: an internal structured record, for example, fields such as asset_type, asset_amount, asset_location, beneficiary_name, and intent_type.

Server maps recognized entities into a predefined schema and stores the resulting structured record in a user-specific data store, enabling reuse across multiple interactions and documents.

### Step 4

Server invokes an emotion analysis process to determine an emotional state of the user.

Server either calls an external emotion analysis API or runs an internal neural network classifier that computes emotion probabilities from the tokenized text.

Input: validated raw text for the current message (and optionally recent message history).

Output: an emotional state label (for example, “high anxiety”, “neutral”) and an associated confidence score.

Server records the emotional state in association with the message and passes it to a control module that will influence prompt generation and response style.

### Step 5

Server combines the structured data and the emotional state to generate a prompt sentence for a generative AI model.

Server selects a template based on the detected intent (for example, will creation, inheritance agreement, advisory reply) and inserts field values such as asset descriptions, beneficiaries, and jurisdiction, as well as instruction text reflecting the emotional state.

Input: structured record (asset information, user intentions) and emotional state label.

Output: a complete prompt sentence in natural language specifying task, constraints, and tone to be imposed on the generative AI model.

Server stores the generated prompt sentence in memory and associates it with the current conversation context.

### Step 6

Server sends the prompt sentence to a generative AI model via a model client module.

Server constructs an API call to the model service, including the prompt sentence, model identifier, and generation parameters (maximum tokens, temperature, sampling strategy).

Input: prompt sentence, model configuration parameters.

Output: a generated text sequence returned by the generative AI model, representing either a legal document draft or advisory text.

Server decodes the token sequence into a character string and verifies that the output meets minimal format and completeness checks (for example, non-empty, presence of required sections).

### Step 7

Server refines the model output using a response post-processing module.

Server analyzes the generated text to check for presence of required clauses such as identification of parties, listing of assets, distribution rules, and signature blocks.

Input: initial generated text from the generative AI model and the structured record specifying required elements.

Output: either (a) a validated document text or (b) a secondary prompt sentence plus refined document text after an additional model call.

Server, if necessary, constructs a secondary prompt (for example, “Here is a draft will. Check for missing clauses and rewrite for clarity . . . ”) and sends it to the generative AI model to obtain an improved version, then selects the refined text as the final document text.

### Step 8

Server generates explanatory or advisory sections aligned with the emotional state.

Server constructs an additional prompt sentence instructing the generative AI model to create plain-language explanations of the legal clauses, with tone adjustments based on the emotional state.

Input: final document text and emotional state label.

Output: explanatory text segments that clarify the meaning of the main clauses in user-friendly language.

Server appends or associates these explanatory sections with the main document text to form a combined content package ready for formatting.

### Step 9

Server converts the combined text content into document-format data using a document rendering module.

Server calls a document layout engine, specifying page size, margins, fonts, and metadata such as user name, creation date, and document type.

Input: final legal document text and optional explanatory text.

Output: a binary document file (for example, a PDF file) generated in a standardized portable document format.

Server writes the binary file to persistent storage and records its file path or storage identifier in the database.

### Step 10

Server encrypts the generated document for secure storage and controlled distribution.

Server generates or retrieves cryptographic keys and applies an encryption algorithm to the document-format data, producing an encrypted file.

Input: unencrypted document-format data and cryptographic key material.

Output: encrypted document-format data and key association records (mapping between document and recipients'decryption information).

Server stores the encrypted file and updates recipient-specific records that associate each designated related party with corresponding decryption information.

### Step 11

Server prepares and executes distribution of the encrypted document to designated related parties.

Server retrieves contact information (for example, email addresses or messaging identifiers) for heirs or other related parties from the structured user data.

Input: encrypted document-format data, mapping records, and recipient contact information.

Output: outbound messages containing document links or attachments, plus separate delivery of decryption information (keys or passwords).

Server uses communication interfaces (email gateways, messaging APIs) to transmit the encrypted document or download links, and sends decryption information via a separate channel, logging each transmission and recording status in the database.

### Step 12

Server initiates and coordinates an electronic payment process when fees are required for document generation or distribution.

Server calls an external payment processing device to create a payment session, specifying amount, currency, and description linked to the document identifier.

Input: document identifier, fee configuration, and user account information.

Output: a payment session URL or token returned from the external payment processor.

Server sends the payment URL or token to the terminal; after the user completes payment, the server receives a payment confirmation (for example, via webhook), verifies the transaction, and marks the corresponding document as paid and eligible for release.

### Step 13

Terminal receives response messages, document summaries, and payment instructions from the server.

Terminal displays a preview of the generated document, explanatory text, and any payment links or confirmation notices in the communication application interface.

Input: response payload from the server containing text summaries, URLs, and status flags.

Output: rendered views on the display and interactive controls (buttons, links) for the user.

Terminal, upon user interaction, opens the payment URL, triggers document download, or requests further actions such as sharing with a legal professional.

### Step 14

User reviews the document preview and advisory information on the terminal.

User verifies content, confirms payment if required, and optionally initiates download or authorizes distribution to designated related parties.

Input: displayed document summary, advisory text, and payment controls.

Output: user commands such as “confirm”, “download”, “send to heirs”, or additional clarifying questions.

Terminal converts these commands into structured requests and sends them to the server for further processing, thus driving subsequent stages of the pipeline.

### Step 15

Server processes follow-up instructions and maintains an ongoing, emotion-aware dialogue.

Server receives new user commands or questions, updates structured data and emotional state if the new input indicates changed feelings (for example, reduced anxiety), and regenerates an updated prompt sentence as needed.

Input: new user messages, updated conversation context, and previous structured records.

Output: additional advisory text, new or revised legal documents, or updated distribution instructions.

Server repeats the sequence of analysis, prompt construction, generative AI invocation, document generation, and secure distribution, maintaining an efficient, integrated workflow that adapts to evolving user needs while reusing existing structured data and emotional state information.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent.

Moreover, when the processing of each of the units mentioned above is performed by an AI, this processing is partly or entirely performed by the AI, however there is no limitation to such examples.

Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

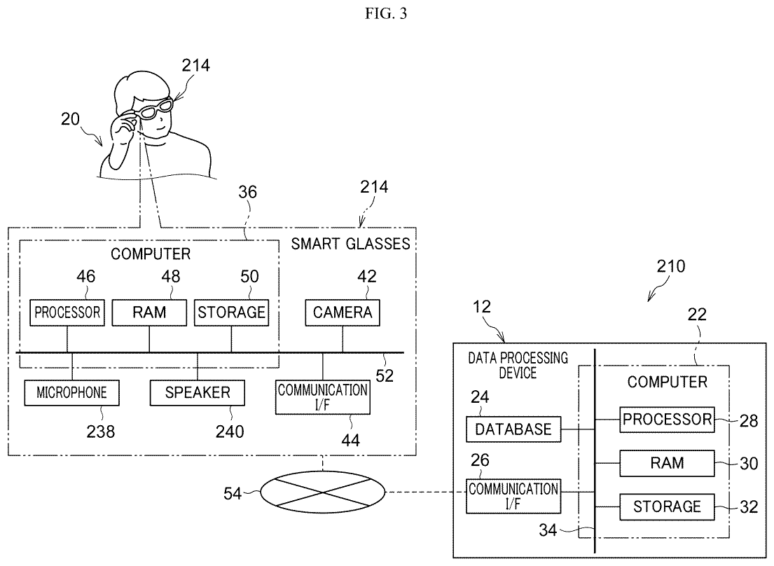

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50.

The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

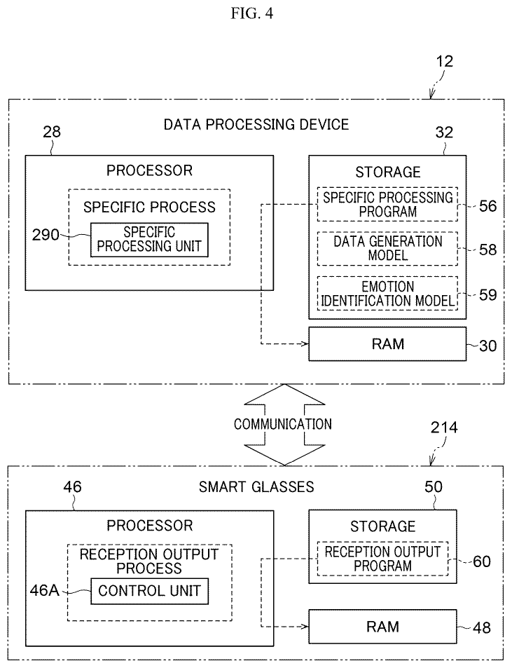

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

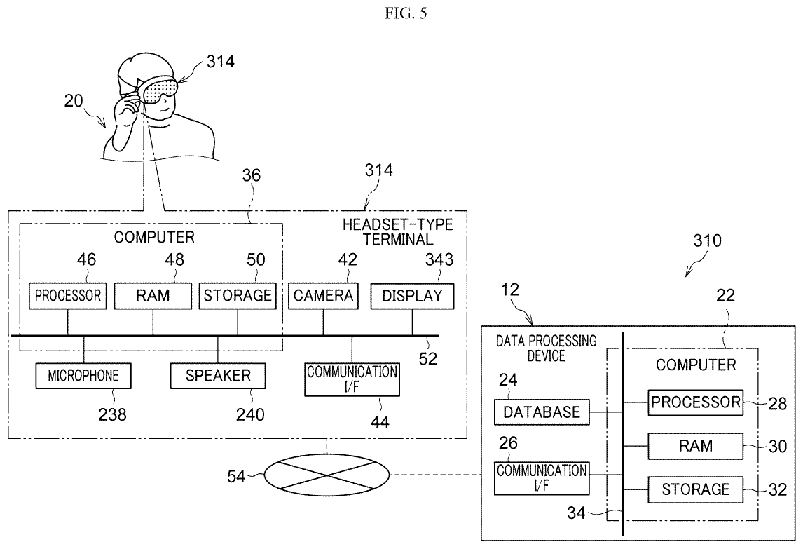

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

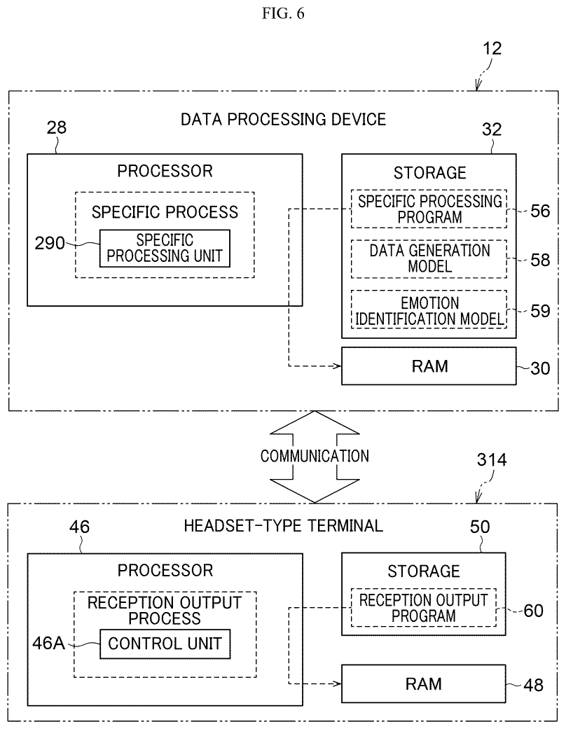

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent.

Moreover, when the processing of each of the units mentioned above is performed by an AI, this processing is partly or entirely performed by the AI, however there is no limitation to such examples.

Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

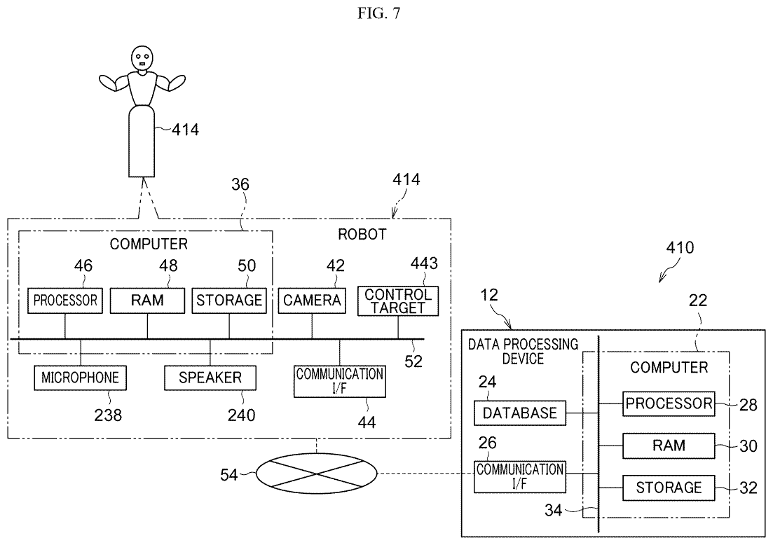

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

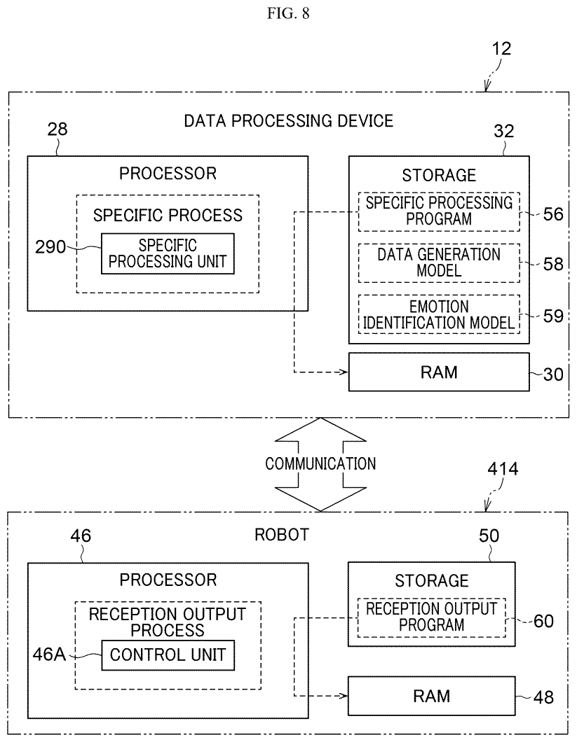

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

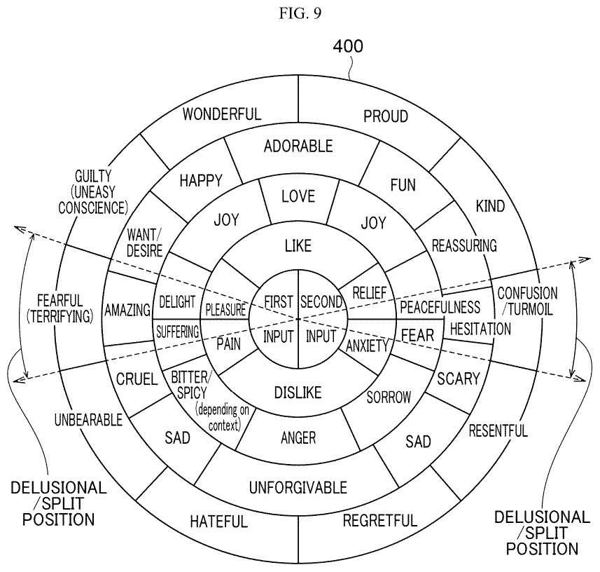

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

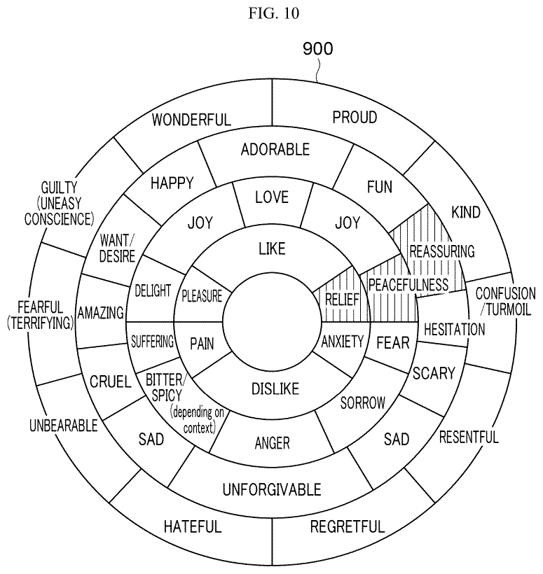

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive character information representing asset information or intention information, the character information being generated by a user inputting the asset information or the intention information as text via a communication application executed on an information processing terminal, convert the character information into structured information, and cause the structured information to be transmitted via an encrypted communication path,
receive the structured information, perform natural language processing on the structured information to extract at least one of an asset category, a beneficiary entity, a location, a quantity, and an evaluation value, generate an analysis prompt sentence including an extraction result and the character information, and input the analysis prompt sentence into a generative AI model,
receive response information output from the generative AI model, generate advice information including at least one of an option presentation, an additional information request, and a procedure guidance based on the response information, and cause the advice information to be displayed on a user interface of the communication application,
store the structured information and the response information in association with stored information in a storage device, and generate official document candidate data by automatically arranging document data, which constitutes at least one of a testament-related document, a funeral-related document, and an inheritance-related document, into a document format using the stored information, and
transmit the official document candidate data in an electronic document format to the information processing terminal and provide the official document candidate data so as to be obtainable via the communication application.

### Supplementary 2

The system according to supplementary 1,
wherein the processor is configured to
extract, from the response information output from the generative AI model, a deficient information item, generate an additional-input prompt sentence including the deficient information item as a concrete additional input request, present the additional-input prompt sentence to the user via the communication application, iteratively acquire additional inputs from the user, and progressively update the stored information and sequentially regenerate the official document candidate data based on the additional inputs.

### Supplementary 3

The system according to supplementary 1,
wherein the processor is configured to
generate a procedure plan including at least one of a funeral-related procedure, an inheritance-related procedure, and an asset-distribution-related procedure, the procedure plan including a procedure category, an execution order, and required information, based on the structured information and the stored information, cause the procedure plan to be displayed on a guidance user interface of the communication application, automatically manage a progress state of each procedure in accordance with an input operation of the user, and change content of the prompt sentence to be input into the generative AI model in accordance with the progress state.

### Application Example 1

### Supplementary 1

A system comprising a processor,
wherein the processor is configured to
receive, via a communication function of a user terminal, input information from a user including asset information and intention information,
generate context information including the asset information, heir candidate information, and intention information by integrating the received input information with history information stored in association with the user,
generate a prompt sentence, based on the context information, for causing a generative information processing model to analyze the input information and to generate an asset management plan and an inheritance distribution plan, and input the prompt sentence to the generative information processing model,
extract and verify, as structured data, an analysis result output from the generative information processing model, and store the structured data as plan information representing the asset management plan and the inheritance distribution plan,
select, based on the analysis result, a format template satisfying legal requirements, and generate document data of a legally effective official document by automatically assigning the plan information and the intention information to the format template, convert the document data into a document file format, store the document file in a storage device, and provide reference information of the document file to the user terminal,
transmit settlement request data to an external electronic settlement service to execute a fund transfer or payment process based on the inheritance distribution plan, and store a response result from the external electronic settlement service in association with the plan information, and
generate and transmit notification information for sharing the official document and the plan information with an heir candidate, based on contact information of the heir candidate registered in association with the user.

### Supplementary 2

The system according to supplementary 1,
wherein the processor is configured to
generate a prompt sentence for causing the generative information processing model to summarize the analysis result output from the generative information processing model, input the prompt sentence to the generative information processing model, generate explanation information in which contents of the asset management plan and the inheritance distribution plan are described in an easy-to-understand manner for the user and the heir candidate, and present the explanation information to the user terminal or an heir candidate terminal via the communication function.

### Supplementary 3

The system according to supplementary 1,
wherein the processor is configured to
manage record information including the asset information, the intention information, the plan information, and the document data in a state during editing while the user is alive and in a state after finalization in a distinguishable manner, add management information indicating a finalized state to the record information in response to a finalization instruction from the user, and designate only the record information having the finalized state as a target for sharing with the heir candidate.

### Example 2

### Supplementary 1

A system comprising a processor,
wherein the processor is configured to
cause a user terminal to provide an input screen through which a user inputs input information including identity information, location information, asset information, and successor information, and to temporarily store the input information as structured data,
receive, via a communication protocol, the structured data transmitted from the user terminal, analyze the structured data to generate a prompt sentence including a document creation target, an applicable legal domain, a document format, clauses to be described, and contents of the input information, and input the prompt sentence to a generative artificial intelligence model,
perform post-processing on text data obtained from the generative artificial intelligence model to format a body structure, heading structure, and clause structure of a legal document corresponding to the input information, convert the text data into a document file format, transmit the document file format to the user terminal, and cause the document file to be displayed on the user terminal so that the user can repeatedly perform confirmation and correction input, and
provide, after final confirmation by the user, the document file in a form storable or outputtable by the user.

### Supplementary 2

The system according to supplementary 1,
wherein the processor is configured to automatically generate the prompt sentence to be input to the generative artificial intelligence model by using the structured data acquired from the user, and include, in the prompt sentence, instruction information for using formal legal expressions, structuring clauses with numbering, and including a clause for invalidation of existing documents and a clause for handling residual assets, thereby automatically creating a legally valid official document.

### Supplementary 3

The system according to supplementary 1,
wherein the processor is configured to
when converting the text data into the document file format, automatically set a document layout, a typeface, page division, and identification information so as to generate a fixed electronic document format, cause the fixed electronic document to be displayable on a communication application or a viewing application, and, based on an editing result by the user, update the structured data and automatically repeat input to the generative artificial intelligence model and regeneration of the document file.

### Application Example 2

### Supplementary 1

A system comprising a processor,
wherein the processor is configured to
receive information input by a user via an information processing device through a communication application,
analyze the received information and generate structured data regarding asset information and user intentions,
perform emotion analysis on the received information and determine an emotional state of the user, generate a prompt sentence to be input to a generative AI model based on the structured data and the emotional state,
input the prompt sentence to the generative AI model and obtain response information including a legal document or an advisory text,
adjust a content and an expression style of the response information in accordance with the emotional state,
generate text data of an official document having legal validity based on the response information, convert the text data into document-format data,
encrypt the document-format data and transmit the encrypted document-format data to designated related parties in association with decryption information,
execute an electronic payment process related to the document-format data in cooperation with an external payment processing device, and
provide, on the communication application, an interactive support screen and present the response information and the document-format data to the user.

### Supplementary 2

The system according to supplementary 1,
wherein the processor is configured to
automatically share the document-format data with inheritance-related parties designated by the user via a communication means using electronic mail or a messaging service.

### Supplementary 3

The system according to supplementary 1,
wherein the processor is configured to
automatically generate, by using the generative AI model, procedure content and execution steps relating to a funeral procedure or a property inheritance procedure based on the structured data and the emotional state, and present the procedure content in a form transmittable to an external service provider or a related party.

What is claimed is:

1. A system comprising:
circuitry configured to:
receive character information from a terminal apparatus via an encrypted communication path, the character information representing entity attribute data and intention data input via a communication interface;
convert the character information into structured information by applying a natural language processing algorithm to extract at least one of a category identifier, a beneficiary entity identifier, a location identifier, a quantity value, and an evaluation value;
construct a parameterized instruction sequence including the structured information and the character information, and provide the parameterized instruction sequence to a generative neural network model to cause the generative neural network model to generate analysis response data;
generate guidance data based on the analysis response data, the guidance data including at least one of option presentation data, additional information request data, and procedure step data; and
generate structured document data by arranging the structured information and the analysis response data into a predetermined document format, and transmit the structured document data to the terminal apparatus via the encrypted communication path.

2. The system according to claim 1, wherein the circuitry is further configured to:
store the structured information and the analysis response data in association with stored information in a storage medium, and generate the structured document data by automatically populating a document template with field values extracted from the stored information.

3. The system according to claim 2, wherein the document template includes a plurality of predefined sections, and wherein the circuitry maps extracted field values to corresponding sections based on a mapping table associating category identifiers with template section identifiers.

4. The system according to claim 3, wherein the circuitry is further configured to:
extract, from the analysis response data, a deficient information item identifier indicating information not present in the structured information, construct an additional-input parameterized instruction sequence including the deficient information item identifier, and transmit the additional-input parameterized instruction sequence to the terminal apparatus as a request for supplementary input data.

5. The system according to claim 4, wherein the circuitry is further configured to:
iteratively receive supplementary input data from the terminal apparatus, update the stored information based on the supplementary input data, and sequentially regenerate the structured document data based on the updated stored information.

6. The system according to claim 1, wherein the circuitry is further configured to:
generate a procedure plan data structure based on the structured information and the stored information, the procedure plan data structure including a plurality of procedure entries each having a procedure category identifier, an execution order value, and required information identifiers.

7. The system according to claim 6, wherein the circuitry is further configured to:
transmit the procedure plan data structure to the terminal apparatus for display on a guidance interface, manage a progress state for each procedure entry in accordance with input operations received from the terminal apparatus, and modify content of the parameterized instruction sequence provided to the generative neural network model in accordance with the progress state.

8. The system according to claim 1, wherein the natural language processing algorithm performs tokenization, part-of-speech tagging, named entity recognition, and dependency parsing on the character information to generate the structured information.

9. The system according to claim 8, wherein the circuitry is further configured to:
generate context information by integrating the structured information with historical interaction data stored in the storage medium in association with the entity, and incorporate the context information into the parameterized instruction sequence.

10. The system according to claim 9, wherein the context information includes an aggregated entity profile comprising accumulated attribute data, previously expressed intention data, and a record of previously generated structured document data.

11. The system according to claim 1, wherein the generative neural network model comprises a transformer-based architecture including an embedding layer, a plurality of self-attention layers, feed-forward layers, and normalization layers, and wherein the circuitry provides the parameterized instruction sequence as a token sequence to the transformer-based architecture together with decoding control parameters including a maximum output token count and a sampling temperature value.

12. The system according to claim 11, wherein the parameterized instruction sequence includes a format compliance directive specifying structural requirements for the analysis response data, such that the generative neural network model returns the analysis response data in a machine-readable structured format including field identifiers and corresponding values.

13. The system according to claim 12, wherein the circuitry is further configured to:
extract and verify the analysis response data as structured data by parsing the machine-readable structured format, validating field values against constraint rules stored in the storage medium, and flagging field values that do not satisfy the constraint rules.

14. The system according to claim 13, wherein the circuitry is further configured to:
select a format template from a plurality of stored format templates based on the category identifier extracted from the structured information, and populate the selected format template with the verified field values to generate the structured document data.

15. The system according to claim 14, wherein the circuitry is further configured to:
convert the structured document data into a portable document format file, store the file in the storage medium, and transmit reference information of the file to the terminal apparatus for retrieval.

16. The system according to claim 1, wherein the circuitry is further configured to:
acquire image data and acoustic data associated with the entity from the terminal apparatus, apply an emotion estimation model to a combined feature vector derived from the image data and the acoustic data to compute emotion classification data, and adapt the guidance data based on the emotion classification data.

17. The system according to claim 16, wherein the emotion estimation model comprises a multi-layer neural network having an input layer, one or more hidden layers with non-linear activation functions, and an output layer that computes probability distributions over a set of emotion category labels.

18. A system comprising:
circuitry configured to:
receive, via an encrypted communication path coupled to a packet-switched network, character information from a terminal apparatus representing entity attribute data and intention data;
apply a natural language processing algorithm to the character information to extract structured information including category identifiers, entity identifiers, and quantity values;
construct a parameterized instruction sequence based on the structured information and historical interaction data stored in a storage medium, and provide the parameterized instruction sequence to a generative neural network model having a transformer-based architecture including a plurality of self-attention layers to generate analysis response data;
generate guidance data and a procedure plan data structure based on the analysis response data;
select a format template based on the category identifiers, populate the format template with field values from the structured information and the analysis response data to generate structured document data; and
transmit the structured document data and the guidance data to the terminal apparatus via the encrypted communication path.

19. The system according to claim 18, wherein the circuitry is further configured to:
iteratively receive supplementary input data from the terminal apparatus, update the stored information, regenerate the structured document data, and modify the parameterized instruction sequence in accordance with a progress state of procedure entries in the procedure plan data structure.

20. A method performed by circuitry, the method comprising:
receiving character information from a terminal apparatus via an encrypted communication path, the character information representing entity attribute data and intention data input via a communication interface;
converting the character information into structured information by applying a natural language processing algorithm to extract at least one of a category identifier, a beneficiary entity identifier, a location identifier, a quantity value, and an evaluation value;
constructing a parameterized instruction sequence including the structured information and the character information, and providing the parameterized instruction sequence to a generative neural network model to cause the generative neural network model to generate analysis response data;
generating guidance data based on the analysis response data; and
generating structured document data by arranging the structured information and the analysis response data into a predetermined document format, and transmitting the structured document data to the terminal apparatus via the encrypted communication path.
